(19) United States
(12) Patent Application Publication
(10) Pub. No.: US 2017/0091409 A1
(43) Pub. Date: Mar. 30, 2017

(54) CANCER THERAPEUTIC WINDOW EVALUATION METHOD

(71) Applicant: Lan Jiang, DALLAS, TX (US)

(72) Inventor: Lan Jiang, DALLAS, TX (US)

(21) Appl. No.: 15/275,897

(22) Filed: Sep. 26, 2016

Related U.S. Application Data
(60) Provisional application No. 62/233,682, filed on Sep. 28, 2015.

(51) Int. Cl. G06F 19/00

(52) U.S. Cl. CPC G06F 19/3418; G06F 19/322

(57) ABSTRACT

A cancer therapeutic window evaluation method is provided. In some embodiments, the method may comprise: detecting tumor oxygenated perfusion by having a patient breathe air to acquire MRI baseline data; inhalation of hyperoxia gas to generate higher than baseline HbO₂ blood circulating in body to acquire MRI enhanced data; the region-of-interest (ROI), which in this case is a tumor volume (V₀), and which may be performed by volume contour tracing/region-of-interest (ROI) analysis and 3D tumor volumetry methods; calculating voxel's enhanced signal intensity (ΔSI); calculating tumor oxygenated perfusion percentage (OPP %); selecting different threshold and calculating maps such as a reconstruction OPP % pseudo color map; calculating tumor volume change ratio (Vt %); overlaying reconstruction OPP % pseudo color map to original images for visualizing tumor response data; drawing or plotting the OPP % and Vt % may on a cancer treatment evaluation diagram, and calculating risk/benefit analysis based on pooled collected data.

### CROSS REFERENCE TO RELATED APPLICATIONS

This application claims priority to and the benefit of the filing date of U.S. Provisional Application No. 62/233,682, filed on Sep. 28, 2015, entitled “CANCER TREATMENT EVALUATION METHOD”, which is hereby incorporated by reference in its entirety.

### FIELD OF THE INVENTION

This patent specification relates to the field of cancer treatment methods. More specifically, this patent specification relates to computer implemented methods of solid cancer treatment evaluation for improving treatment outcomes.

### BACKGROUND

Although there are multiple therapeutic modalities (Chemotherapy, Radiotherapy, Immunotherapy, Molecular Targeted Therapy, etc.) available for cancer treatment in the clinical setting, oncologists still face the challenge of selecting the right therapeutic approach for each patient and balancing relative benefit with risk to achieve the most successful outcome. This risk/benefit ratio is estimated via extrapolations from the results of clinical trials conducted in larger patient populations who share similar clinic-pathological characteristics with the individual, such as sex, age, histopathology, and disease stage. Beside the difference in cancer cell genomic information, the difference in tumor physiological microenvironment characteristics demonstrated by different forms of cancer and even by similar forms of cancer also show a large amount of variability which can cause huge variations in response to the same treatment between individual patients. Studies have shown that the tumor region's microenvironment, especially microcirculation perfusion, is vastly different from normal tissue, as represented by insufficient blood-oxygen perfusion (blood flow per unit volume) and hypoxia inside the tumor. This poor microcirculatory perfusion factor causes suboptimal distribution of systemic treatment drug/agent to the tumor and is directly linked to drug/agent treatment failure in blood-borne therapies (Chemotherapy, Targeted therapy, Immunotherapy, Gene therapy, and Photodynamic therapy, etc.). Additionally the poor microcirculatory perfusion factor can lead to serious hypoxia causing therapeutic resistance in radiotherapy and part of blood-borne therapies. Because of the high heterogeneity of microcirculatory perfusion and oxygenation level both inter- and intra-tumor, it is one reason that the same stage patients with the same treatment can vary widely in outcome among patients. Meanwhile, the tumor microcirculatory perfusion can be longitudinally changed with tumor shrinkage during treatment course, which also may cause huge variation in outcome.

Currently, traditional medical treatment practice has been limited by the fact that it does not adequately account for tumor possible physiological microcirculatory perfusion factors and their differences between individuals and populations, and dynamic changes during treatment course. If the tumor volume is used as only parameter in monitoring and evaluating response to previous therapy during course, for example, it may delay identifying ineffective therapy in clinic because blood-borne therapies and irradiation therapies usually takes multiple courses over and about several weeks. A delay in identifying ineffective therapy may miss the opportunity of correcting treatment, decrease patients' quality of life, and increase cost of healthcare.

Therefore, a need exists for novel methods of precision medicine which are able to provide the individualization of each patient's treatment for improving efficiency, which offers the ability of matching the right treatments to the right patients at the right time point to improve patient outcomes and quality of life. There also exists a need for novel cancer therapeutic window evaluation methods as routine for reducing both exposure to ineffective therapies and the cost of cancer care. There is a further need for novel cancer therapeutic window evaluation methods which are able to visually aid in identifying, tracking, evaluating, and optimizing cancer therapy for customized evidence-based cancer treatment. There exists a need for novel cancer therapeutic window evaluation methods that can help to early identify cancer patient who has Multiple Drug Resistance (MDR) to chemotherapy drugs during the course of therapy. There exists a need for novel cancer therapeutic window evaluation methods that can share treatment information of different therapeutic modalities on one platform for comprehensively analyzing treatment and searching the best therapeutic strategy. Finally, there exists a need for novel cancer therapeutic window evaluation methods that provide the ability of real-time monitoring therapeutic response in adjusting and optimizing of current treatment plan during treatment course for achieving maximum efficacy in clinical setting.

### BRIEF SUMMARY OF THE INVENTION

A computer implemented cancer therapeutic window evaluation method is provided. In some embodiments, the method may comprise: detecting tumor oxygenated perfusion by having the patient breathe air to acquire baseline data via dynamic T2-weighted MR imaging technique; inhalation of hyperoxia gas to generate higher than baseline HbO₂ blood circulating in body and to acquire tumor enhanced data with same parameters of dynamic T2-weighted MR imaging technique and same tumor region; the region-of-interest (ROI), which in this case is a tumor volume (Vt), and which may be performed by volume contour tracing/region-of-interest (ROI) analysis and 3D tumor volumetry methods are performed; calculating voxel's enhanced signal intensity (ΔSI); calculating tumor oxygenated perfusion percentage (OPP); calculating different threshold maps such as a Reconstruction OPP % pseudo color image; calculating tumor volume change ratio (Vt %); creating special threshold maps to visualize the data such as using Reconstruction OPP % to form a pseudo color map of the data which can be fusion with original MRI image dataset and CT image dataset; adding a margin to the Reconstruction OPP % map for sub-clinical disease spread which therefore cannot be fully imaged as the clinical target volume (CTV); adding another margin to allow for uncertainties in planning or treatment delivery as the planning target volume (PTV) which can be used for radiation treatment plan in biologically guided radiation therapy; guiding tumor intensity-modulated radiation therapy (IMRT) with dose painting based on tumor oxygenated information; and drawing or plotting the OPP % and Vt % on a cancer treatment evaluation diagram.

In some embodiments, the method may be performed with an electronic device comprising a processor, a data input/output device, and a display input/output device, and the method may comprise: acquiring tumor baseline data of the particular patient generated by dynamic contrast enhanced T2-weighted MR imaging technique with a data input/output device; acquiring tumor enhanced data of the particular patient with increasing body blood oxyhemoglobin (HbO₂) concentration, which is generated by same dynamic contrast enhanced T2-weighted MR imaging technique, with a data input/output device; calculating tumor volume based on acquired tumor T2-weighted MR imaging data with the processor; calculating the tumor volume change ratio (Vt %) data with the processor; calculating tumor voxel's enhanced signal intensity (ΔSI) data with the processor; calculating tumor oxygenated perfusion percentage (OPP %) data with the processor; calculating different thresholds of oxygenated perfusion percentage OPP % data and maps with the processor; creating special threshold maps with the processor; plotting OPP % data and Vt % data of the particular patient on the evaluation diagram with the processor on the display input/output device; and calculating a risk/benefit analysis for a cancer therapy treatment scheme based on the pooled cancer therapy data of one or more other patients.

According to another embodiment consistent with the principles of the invention, a cancer treatment evaluation diagram is provided. In some embodiments, the diagram may comprise two independent symmetrical coordination systems as a triangle structure comprising three apexes which may be oriented to different cancer therapy modalities. A poor oxygenated perfusion apex, optionally oriented at the top of the triangle, may indicate cancer tumors with poor oxygenated perfusion and the well oxygenated perfusion apexes optionally oriented at the bottoms of the triangle, may indicate cancer tumors with well oxygenated perfusion. Additionally, a change in tumor volume coordinate graph may extend from the two sides of the diagram. In this manner each side of the diagram may be used as a coordinate graphing system which each side functioning as a coordinate graphing system for a type of cancer therapy or treatment. For example, the left side may function as a graphing system for a blood-borne drug/agent therapy and the right side may function as a graphing system for an irradiation therapy. In further embodiments, the diagram may show numbers of treatment on each side.

The computer implemented cancer therapeutic window evaluation method described herein able to visually provide previous therapeutic responses and possible outcome which can be displayed on a diagram and which is visualized for patients easily to understand. Patients should have the right to know enough treatment information and they should have own options for their cancer treatment. The cancer therapeutic window evaluation method described herein helps patients to gain professional knowledge and understand possible outcomes for protecting themselves away from ineffective treatment. The ineffective treatments, especially ineffective over-treatments, have to be eliminated which influence patient quality of life and cause great costs of social resource.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a block diagram of an example of a cancer therapeutic window evaluation method according to various embodiments described herein.

FIG. 2 illustrates an example of a cancer treatment evaluation diagram according to various embodiments described herein.

FIG. 3 shows an example of a cancer treatment evaluation diagram which describes an ineffective chemotherapy cancer treatment according to various embodiments described herein.

FIG. 4 depicts an example of a cancer treatment evaluation diagram which describes an effective chemotherapy cancer treatment according to various embodiments described herein.

FIG. 5 illustrates an example of a cancer treatment evaluation diagram which describes an effective radiotherapy cancer treatment according to various embodiments described herein.

FIG. 6 shows an example of a cancer treatment evaluation diagram which describes an effective chemo-radiotherapy combination treatment according to various embodiments described herein.

FIG. 7 depicts an example of a block diagram of a server which may be used to perform one or more steps of the computer implemented cancer therapeutic window evaluation method according to various embodiments described herein.

FIG. 8 illustrates an example of a block diagram of an electronic device which may be used to perform one or more steps of the computer implemented cancer treatment evaluation method and to generate a cancer treatment evaluation diagram according to various embodiments described herein.

FIG. 9 shows an illustrative example of some of the components and computer implemented methods which may be found in a cancer treatment evaluation system according to various embodiments described herein.

FIG. 10 depicts a block diagram illustrating some applications of a cancer treatment evaluation system which may function as software rules engines according to various embodiments described herein.

FIG. 11 illustrates a block diagram of an example of a method for generating an estimation of how the cancer of a particular patient would respond to a cancer therapy according to various embodiments described herein.

FIG. 12 illustrates an example construction of a cancer therapeutic window evaluation diagram according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As used herein, the term “cancer or tumor” refers to the mammalian, such as a human, solid tumor or solid cancer in any site which can be detected by Magnetic Resonance Imaging (MRI).

As used herein, the term “computer” refers to a machine, apparatus, or device that is capable of accepting and performing logic operations from software code. The term “application”, “software”, “software code” or “computer software” refers to any set of instructions operable to cause a computer to perform an operation. Software code may be operated on by a “rules engine” or processor. Thus, the methods and systems of the present invention may be performed by a computer or computing device having a processor based on instructions received by computer applications and software.

The term “electronic device” as used herein is a type of computer or computing device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include: personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include: cell phones, smartphones, tablet computers, laptop computers, and wearable computers such as Apple Watch, other smartwatches, Fitbit, other wearable fitness trackers, Google Glasses, and the like.

The term “user device” or sometimes “electronic device” or just “device” as used herein is a type of computer or computing device generally operated by a person or user of the system. In some embodiments, a user device is a smartphone or computer configured to receive and transmit data to a server or other electronic device which may be operated locally or in the cloud. Non-limiting examples of user devices include: personal computers (PCs), workstations, laptops, tablet PCs including the iPad, cell phones including iOS phones made by Apple Inc., Android OS phones, Microsoft OS phones, Blackberry phones, or generally any electronic device capable of running computer software and displaying information to a user. Certain types of user devices which are portable and easily carried by a person from one location to another may sometimes be referred to as a “mobile device” or “portable device”. Some non-limiting examples of mobile devices include: cell phones, smartphones, tablet computers, laptop computers, wearable computers such as Apple Watch, other smartwatches, Fitbit, other wearable fitness trackers, Google Glasses, and the like.

The term “computer readable medium” as used herein refers to any medium that participates in providing instructions to the processor for execution. A computer readable medium may take many forms, including but not limited to, non-volatile media, volatile media, and transmission media. Non-volatile media includes, for example, optical, magnetic disks, and magneto-optical disks, such as the hard disk or the removable media drive. Volatile media includes dynamic memory, such as the main memory. Transmission media includes coaxial cables, copper wire and fiber optics, including the wires that make up the bus. Transmission media may also take the form of acoustic or light waves, such as those generated during radio wave and infrared data communications.

As used herein the term “data network” or “network” shall mean an infrastructure capable of connecting two or more computers such as user devices either using wires or wirelessly allowing them to transmit and receive data. Non-limiting examples of data networks may include the internet or wireless networks or (i.e. a “wireless network”) which may include Wifi and cellular networks. For example, a network may include a local area network (LAN), a wide area network (WAN) (e.g., the Internet), a mobile relay network, a metropolitan area network (MAN), an ad hoc network, a telephone network (e.g., a Public Switched Telephone Network (PSTN)), a cellular network, or a voice-over-IP (VoIP) network.

As used herein, the term “database” shall generally mean a digital collection of data or information. The present invention uses novel methods and processes to store, link, and modify information such digital images and videos and user profile information. For the purposes of the present disclosure, a database may be stored on a remote server and accessed by a user device through the internet (i.e., the database is in the cloud) or alternatively in some embodiments the database may be stored on the user device or remote computer itself (i.e., local storage). A “data store” as used herein may contain or comprise a database (i.e. information and data from a database may be recorded into a medium on a data store).

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New computer implemented cancer therapeutic window evaluation methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

Cancer is a complicated disease to treat in clinic. The best strategy is to use systematically therapeutic modalities to achieve the max efficacy and improve patient quality of life. The cancer therapeutic window evaluation method provided establishes a general therapeutic information platform for serving different therapeutic modalities (Blood-borne therapies, Irradiation therapies and surgery). Oncologists with different therapeutic backgrounds can share patient therapeutic responses on one therapeutic information platform for reviewing and searching the best treatment window. Based on these individual prognostic information, ineffective treatments can be reduced or eliminated and the patient can be treated by the most effective evidence-based therapeutic modality and plan for achieving the precision cancer treatment.

The low drug/agent dose concentration in tumor region is considered as one of main reasons contributing to therapy resistance in blood-borne drug/agent therapies (Chemotherapy, Immunotherapy, Gene Therapy, Photodynamic Therapy, Molecularly Targeted Therapy, etc). Poor drug/agent dose distribution cases may be caused by ineffective tumor microcirculatory perfusion if ignore the difference in tumor vascular permeability. Clinical statistics studies demonstrate that there are majority of human cancer patients with ineffective treatment and only a small percentage of cancer patients (for example, only 30% breast cancer patients) shows a complete or partial response to chemotherapy. Therefore, clinicians need to detect tumor prognostic information (such as, microcirculatory perfusion) for predicting outcome and designing the best strategy which reduce exposure to ineffective therapy and costs of healthcare.

Currently, oncologists design therapeutic treatment schemes based on risk/benefit ratios estimated from extrapolations of the results of clinical trials conducted in larger patient populations who share similar clinic-pathological characteristics with the individual. If oncologists have information of individual patient's dose possible distribution, especially dose peak, dose concentration curve, and duration in tumor, it can greatly help oncologists to design the most effective therapy scheme and eliminate ineffective treatment. For example, poor tumor microcirculatory perfusion may case a poor response to Maximum Tolerated Dose (MTD) therapy scheme because it is difficult to reach enough fatal dose concentration in tumor cells during chemotherapy.

Studies show that hypoxia (poor oxygenated perfusion region) demonstrates strong therapeutic resistance in radiotherapy. In order to overcome tumor hypoxia causing resistance, the irradiation dose must be escalated three times comparing with well oxygenation tumor regions in radiotherapy for achieving same effect. However, over-dose of radiation can increase the risk of second cancer in normal tissue. The computer implemented cancer therapeutic window evaluation method described herein provides a volume, location of MR imaging dataset and spatial position of poor oxygenation perfusion (hypoxia) regions, which can be fusion MRI dataset and CT dataset to generate the planning target volume (PTV) for radiation treatment planning in biologically guided radiation therapy. It can assist oncologists to target hypoxic region accurately with increased more dosage on hypoxic/low oxygenation regions for adjusting individual intensity-modulated radiation therapy (IMRT) plan, optimizing fractionated dose and total dose during course of radiotherapy and achieving a biologically guided radiotherapy.

The tumor volume can be varied during treatment course. The shrinkage of a tumor can cause a change in flow dynamics and microcirculatory pattern intra-tumor. With dynamic change of tumor circulatory pattern, it must alter intra-tumor oxygenated perfusion and the response of the following therapy during the course of treatment. In other words, the tumor therapeutic window could be dynamically changed. So, as important prognosis parameter, monitoring the dynamic change of tumor oxygenated perfusion (therapeutic window) during treatment course shows a significant meaning in precision cancer treatment. The cancer therapeutic window evaluation method described herein can provide an approach to monitor tumor therapeutic response in order to adjust and re-optimize therapeutic scheme during the course of blood-borne therapies.

With change of tumor microcirculatory pattern, the tumor oxygenation distribution can be changed during fractionated radiotherapy. For example, tumor hypoxic cancer cells can be re-oxygenated during fractionated radiotherapy, referred to as reoxygenation, which is considered a positive marker in response to fractional radiotherapy. If reoxygenation, as a positive therapeutic window, occurs during initial fractional radiotherapy, it may predict a good outcome which may provide a tool in optimizing fractional treatment for achieving max efficacy. The cancer therapeutic window evaluation method described herein can provide an approach to monitor tumor reoxygenation information for radiotherapy.

In summary, the treatment outcome of cancer is highly related to capability of drug/agent/oxygen distribution inside tumor. A poor drug/agent/oxygen distribution represents strong therapeutic resistance in blood-borne drug/agent therapies and radiotherapy. The cancer therapeutic window evaluation method described herein can identify possible ineffective therapeutic window due to poor drug/agent/oxygen distribution and possible effective therapeutic window for blood-borne therapies and radiotherapy. For example, designing effective chemotherapy must consider five basic pharmacologic and pharmacodynamics factors, (1) dose, (2) schedule, (3) maintenance of the dose level of the agents above a critical duration of exposure, (4) distribution, metabolism, and disposition of the drug, and (5) therapeutic index of the drug. The cancer therapeutic window evaluation method described herein can provide oncologists possible information of drug/agent distribution inside tumor for designing the best therapeutic strategy.

Cancer Blood Perfusion Characteristics:

Microcirculation is the circulation of the blood in the smallest blood vessels, present in the vasculature embedded within organ tissues. The main functions of blood in the microcirculation are the delivery of oxygen (O₂), nutrients, drug/agent and the removal of carbon dioxide (CO₂). When blood flows through a tumor local region, the blood flow can be divided into two kinds of perfusion in tumor region based on contributing to local oxygenation. One is called oxygenated blood perfusion (oxygenated perfusion) which comes from arteries system of normal host with high HbO₂ concentration blood perfusion. It is carrying more oxygen and nutrients to the local region, hence the name oxygenated perfusion. The well oxygenated perfusion regions correlate to effective circulation of higher oxygenated blood, better oxygen delivery and distribution, and relative higher oxygenation level around vascular region. If the difference of tumor vascular permeability is ignored, the well oxygenated perfusion regions correlate to better drug/agent/oxygen delivery and distribution in same region. Multiple Drug Resistance (MDR), the principal mechanism by which many cancers develop resistance to chemotherapy drugs, is one of main reasons of failure in treatment. It is a very serious problem that may lead to recurrence of disease or even death. Studies show many reasons can cause cancer drug resistance. The mechanisms underlying chemotherapy failure can be divided into two broad categories: cell-specific factors and pharmacological/physiological factors. Cellular mechanisms of drug resistance (those taking place directly within the tumor cell involved in drug resistance), especially in the case of multidrug resistance (MDR), may occur simultaneously and/or sequentially, and may be switched on and off during the establishment of a drug-resistant phenotype. The pharmacological/physiological factors is highly related to such as drug metabolism, excretion, inadequate access of the drug to the tumor, inadequate infusion rate and inadequate route of delivery. Similar to MDR, the drug resistance (DR) of new targeted therapy drugs has been found in clinical setting. It is hard to early detect drug resistance during the course of cancer therapy as clinical routine. In some embodiments, the oxygenated perfusion percentage data OPP % and volume change ratio Vt % data obtained before and during the cancer treatment course for a patient 501 may be plotted on the treatment evaluation diagram 200 to determine if the patient has drug resistance cancer. If better drug/agent distribution doesn't equate with a better outcome, such as a decrease in tumor volume, during course of cancer therapy, it may be considered the drug resistance of the cancer cells to the chemotherapy agents or targeted drugs in the administered for blood-borne therapies. In this manner, by plotting information on the diagram 200, a clinician is able to early identify MDR/DR in order to optimize treatment plan and eliminate treatment that is ineffective and merely harmful during course. The tumor oxygenated perfusion happens only at “fresh” arterial blood flowing-in part; diagram 200 can be a very important parameter for evidence-based cancer medicine.

Due to the cancer cells' high metabolism around vessel, oxyhemoglobin (HbO₂) concentration of flowing blood is gradually shifted towards lower values until it reaches the background of oxygenation level around tissue. The second type of perfusion is the oxygen equilibration perfusion, which means less oxygen exchanging between blood and around tissue in local tumor region. Generally, the tumor local regions with mostly low/non oxygenated perfusion flowing through are still low oxygenation or hypoxia regions, hence the name poor oxygenated perfusion. Physiologically, the poor oxygenated perfusion can be caused by either perfusion with low/non oxygenated blood or by no blood perfusion in tumor region. Poor oxygenated perfusion tumors highly correlate to therapeutic resistance in blood-borne therapies (such as chemotherapy, molecular targeted therapy, immunotherapy, gene therapy, photodynamic therapy) and radiation therapy, which should be considered during optimizing treatment plan in clinical setting.

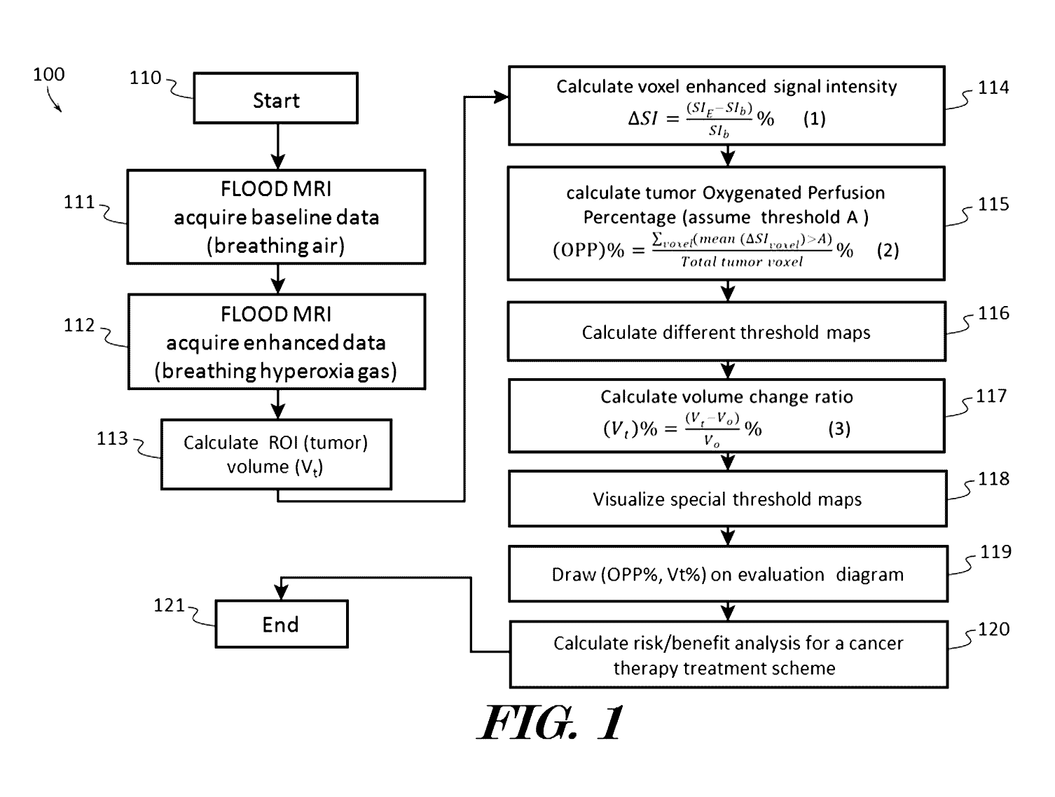

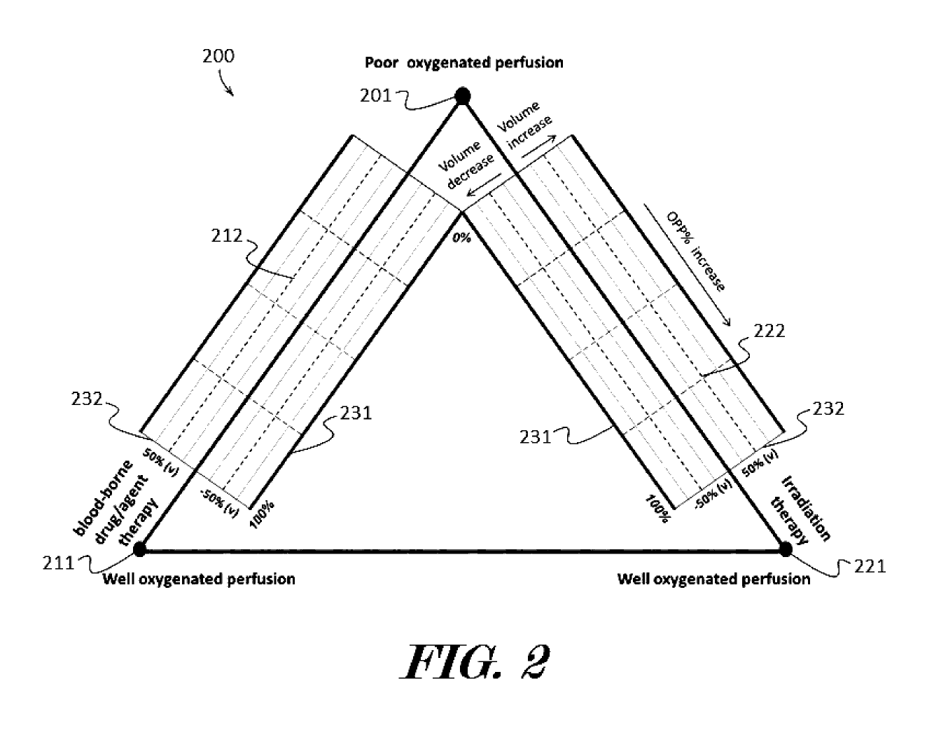

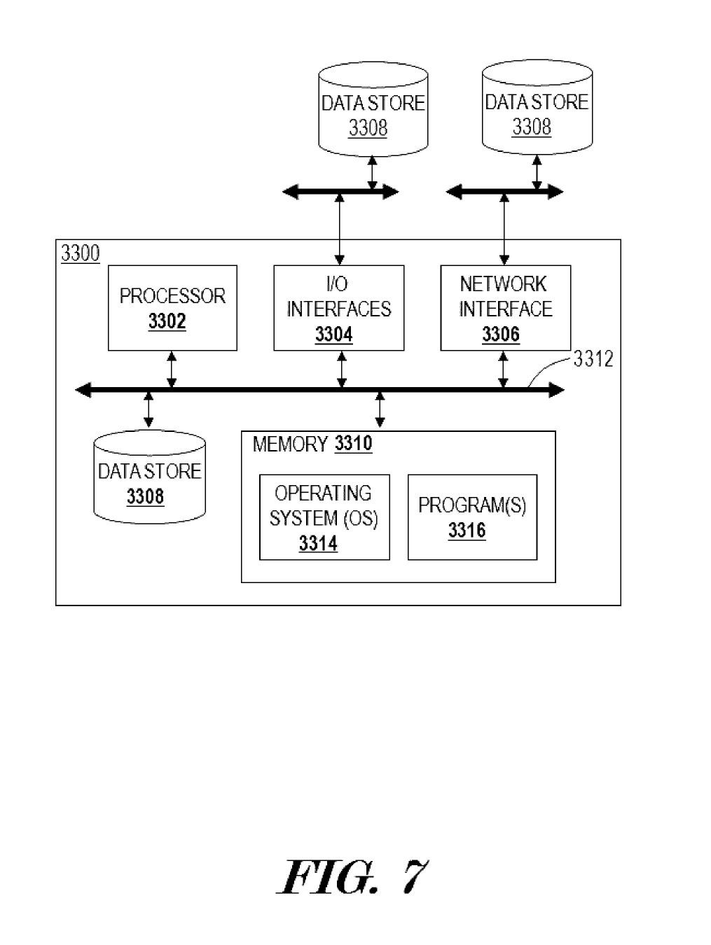

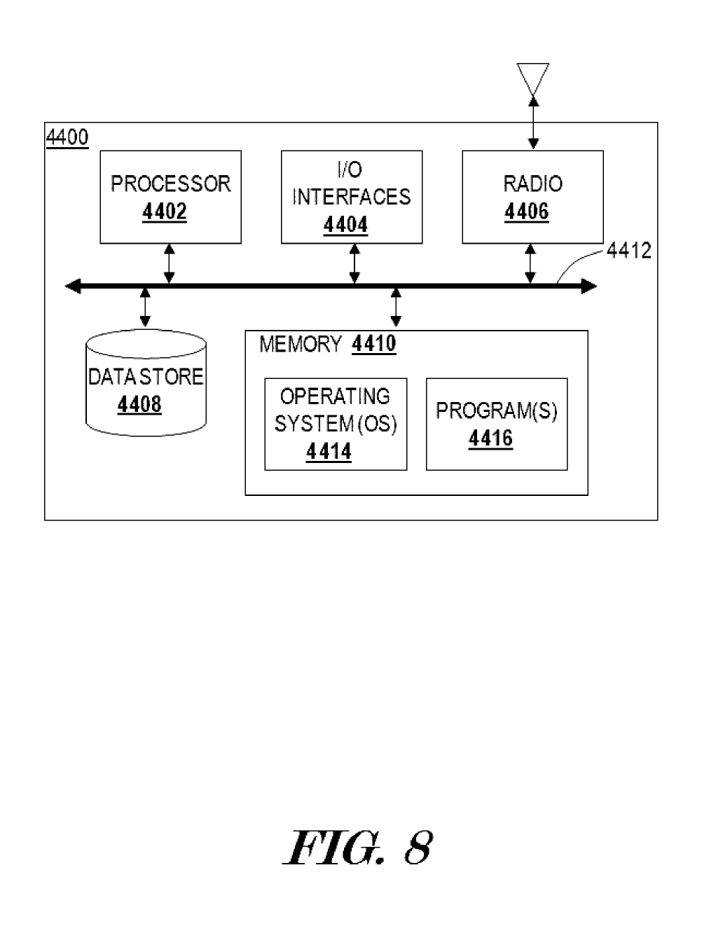

The present invention will now be described by example and through referencing the appended figures representing preferred and alternative embodiments. FIG. 1 illustrates a block diagram of an example of a computer implemented cancer therapeutic window evaluation method (“the method”) 100 according to various embodiments. In some embodiments, one or more steps 110-120 may be performed on an electronic device 4400 (FIG. 8) and/or on a server 3300 (FIG. 7). The method 100 may be used to create a treatment evaluation diagram 200 (FIGS. 2-6) for treatments including, but not limited to Blood-borne therapies, such as Chemotherapy, Molecularly Targeted therapy, Immunotherapy; Gene therapy, and Photodynamic therapy, Irradiation therapies, such as Radiotherapy, and Hyperthermia Therapy, and Combination therapies, such as chemotherapy-radiotherapy, immunotherapy-radiotherapy, molecularly targeted therapy-radiotherapy, radiosensitizer-radiotherapy, other Blood-borne therapies-irradiation therapies for a particular patient 501. In some embodiments, one or more steps 110-121 may be performed during, before, or after a cancer therapy treatment. In further embodiments, one or more steps 110-121 may be performed during, before, or after a cancer therapy treatment scheme. In some embodiments, the method 100 may be used for the treatment of human solid tumors, although in further embodiments, the method 100 may be used for the treatment of solid tumors in any mammal or other organism.

In some embodiments, the method 100 may start 110 and the tumor oxygenated perfusion may be detected by using a Flow and Oxygenation Dependent (FLOOD) contrast MRI (dynamic contrast enhanced T2 weighted MR imaging) technique, which is sensitive to which is sensitive to both vascular oxygenation and flow. In further embodiments, the tumor oxygenated perfusion may be detected having the patient breathe air to acquire baseline data in step 111. Next, after inhalation of hyperoxia gas to generate intrinsic contrast agent (high HbO₂) and higher than baseline HbO₂ blood circulating in body, the enhanced data may be acquired in step 112. When higher HbO₂ blood flow through tumor region comparing with difference of HbO₂ between baseline breathing air and hyperoxia gas in same region, the dynamic T2-weighted MRI technique can detect an enhanced MRI signal intensity which is positively related to difference range of HbO₂ in same region. The unique advantage of this intrinsic contrast enhanced imaging technique comparing with extrinsic contrast agent (such as Gd-DTPA) injection, high HbO₂ blood (intrinsic contrast agent) flowing though tumor region is gradually decayed and finally equilibrated the baseline oxygenation around tissue; the enhanced effect is gradually decreased to zero. In other words, the enhanced effect of MRI signal is mostly sensitive to flowing oxygenated perfusion part.

Although tumor oxygenated perfusion is related to tumor perfusion, physiologically, tumor regions with low/non-oxygenated perfusion may not correlate to the regions with low perfusion. Conversely, high oxygenated perfusion regions must correlate to relative high oxygenation regions around vessel.

Using Dynamic Contrast Enhancement (DCE) MRI technique and extrinsic contrast agents, tumor perfusion is calculated by a complex pharmacokinetic equation. Methods of evaluation include visual inspection of data in movie format, inspection of graphs of signal intensity vs. time, empirical institution dependent measurements and pharmacokinetic modeling using multi-compartment analysis. The calculation of tumor perfusion is easily affected by tumor vascular permeability. It is hard to distinguish tumor oxygenated perfusion via DCE MRI technique.

Based on injecting extrinsic contrast agent enhancement MRI technique to measurement tumor perfusion, it also has technological limitation to monitor tumor response to therapy because of decreasing tumor vascular permeability during treatment course. The signal intensity of MRI for pharmacokinetic modeling analysis highly relate to the tumor vascular permeability. Some chemotherapy can directly cause the change of tumor vascular permeability during treatment course. Due to change of vascular permeability, it can cause wrong information to evaluate tumor response during treatment course, which has been proved by clinical studies.

For these reasons, the method 100 may use oxygenated perfusion percentage as acquired by FLOOD MRI technique or dynamic contrast enhanced T2-weighted MR imaging technique which is not influenced by vascular permeability. The blood deoxyhemoglobin (dHbO₂) is paramagnetic and the blood oxyhemoglobin (HbO₂) is non-paramagnetic. The blood oxyhemoglobin (HbO₂) as an intrinsic contrast agent can enhance MRI signal intensity via using special dynamic T2-weighted MRI pulse sequence and imaging protocol. By analyzed the enhanced signal intensity of tumor region when body blood oxyhemoglobin (HbO₂) concentration being increased, the tumor oxygenated perfusion region can be detected in clinical setting. With decrease of blood oxyhemoglobin (HbO₂) concentration and finally reaching equilibration of the oxygenation around tissue, the enhanced effect is gradually decreased to zero no matter what blood perfused tumor region. The regions with higher oxygenated perfusion flowing through comparing with baseline and higher enhanced signal intensity (ΔSI) are directly related to regions with higher perfusion refresh rate. The high oxygenated perfusion percentage tumor represents relative high perfusion refresh rate and easily reach the drug/agent dose peak, better dose concentration. Based on these information, oncologists can easily design and optimize the evidence-based therapeutic scheme for precision cancer treatment.

The Flow and Oxygenation Dependent (FLOOD) or dynamic contrast enhanced T2-weighted MRI technique can be performed on clinical human 1.5 T or 3 T (or other magnet strength) MRI scanner system. The imaging protocol includes: each measurement procedure can be divided into baseline and enhancement two stages. Baseline imaging in step 111 may be performed echo-planar dynamic contrast enhanced T2-weighted MRI imaging while the patient breathing room air. The number of baseline measurement points may be more than one. The dynamic contrast enhancement imaging is to perform with same scanning parameters and without changing patient's position when patient breathing hyperoxia gas for generating high HbO₂ blood in patient body in step 112. The continual MR scanning throughout is performed to image tumor whole region during whole procedure. In some embodiments, because of totally non-invasive MR imaging approach, any number of dynamic contrast enhanced T2-weighted MRI measurements (such a one, two, three, four, five, six, seven eight, nine, ten, or more,) may be taken to monitor tumor oxygenated perfusion during a patient's treatment for cancer. In further embodiments, the pre-treatment MRI measurement may be taken as control and compared with following measurements during the course of treatment. The tumor volume (V_{O}) of pre-treatment measurement may serve as a control for calculating volume change ratio during evaluation of the course of treatment. The step 111 and step 112 are from published papers (common knowledge).

In further embodiments, step 111 and/or step 112 may be performed by an Input/Output (I/O) Interface 4404 (FIG. 8), 3304 (FIG. 7), of a server 3300 and/or an electronic device 4400. The data acquired in steps 111 and 112 may be stored in a data store 4408 (FIG. 8), 3308 (FIG. 7), and be accessible to a processor 4402 (FIG. 8), 3302 (FIG. 7). The processor 4402, 3302, may then calculate the region-of-interest (ROI) volume (Vt) of the tumor, which may be performed by volume contour tracing/region-of-interest (ROI) analysis 3D tumor volumetry methods in step 113 which is based on intensity threshold of the T2-weighted MRI images. The tumor regions generally show relatively high signal intensity in T2-weighted MRI images comparing with around normal tissue. The tumor ROI region define and alone gave unacceptable overlap of intensity distributions for tumor and normal tissue. In some cases, it may need to do original data processing for motion correction before analyzing data. The step 113 is from common knowledge.

Next, in step 114, the processor 4402 (FIG. 8), 3302 (FIG. 7) may calculate voxel's enhanced signal intensity (ΔSI) may be calculated. In some embodiments, data analysis may be performed on a voxel-by-voxel basis.

The relative signal intensity (ΔSI) of each tumor voxel may be analyzed using the equation:

$$Δ SI = \frac{( {SI}_{E} - {SI}_{b} )}{{SI}_{b}} \% \qquad ( 1 )$$

Where, SI_{E} refers to the enhanced signal intensity in the voxel and SI_{b} is defined as the average of the baseline images in same voxel. The mean signal intensity-time curve of tumor is used to evaluate quality of measurement. The smooth processing is used to eliminate unstable points due to patient motion. The step 114 is from common knowledge.

In step 115, tumor oxygenated perfusion percentage (OPP) may be calculated by the processor 4402 (FIG. 8), 3302 (FIG. 7). The threshold A may be selected as classify high and low contrast enhanced signal (ΔSI) in voxel basis in order to assess whole tumor oxygenated perfusion status. The voxels of the relative signal intensity (ΔSI) being higher than threshold A is counted as high oxygenated perfusion voxel. The percentage of the higher oxygenated perfusion voxel is counted and defined as parameter for evaluating tumor oxygenated perfusion. The higher oxygenated perfusion percentage represents tumor with more oxygenated perfusion inside tumor and better drug/agent/oxygen delivery and distribution. The oxygenated perfusion percentage factor of tumor can be quantified by following equation:

$$( OPP ) \% = \frac{{\sum }_{voxel} ( mean ( Δ {SI}_{voxel} ) > A )}{Total tumor voxel} \% \qquad ( 2 )$$

Where, the threshold A is selected as a percentage based on the MR imaging pulse sequence, TR/TE time, magnet strength of clinical scanner, sensitivity of coil, cancer site, and etc. . . . . For example, it can be assumed a standard threshold 10% for 1.5 T and 15% for 3 T MRI scanner. The OPP % factor represents the how many percent tumor regions with oxygenated perfusion above threshold level A, which is an important prognostic factor for next treatment and can be dynamic changed with treatment course. The higher OPP % represents tumor with the better oxygenated perfusion. Conversely, the lower OPP % represents the poor oxygenated perfusion in tumor region, thereby clarifying the prognostic value of tumor oxygenated blood perfusion.

Next, in step 116, the different threshold set can be processed and different threshold maps may be calculated by processor 4402 (FIG. 8), 3302 (FIG. 7) such as a reconstruction OPP % pseudo color image for better visualization. Several threshold values (such as 0%, 5%, 10%, 20%, and 30%) can be used to classify each voxel and respectively pseudo color value. For example, assign pseudo color values (1, 50, 100, 150, 200, 250) to voxel's relative signal intensity (ΔSI) respectively (<0%, 0%˜5%, 5%˜10%, 10%˜20%, 20%˜30%, >30%) which respectively correspond to a color table (dark blue, blue, light blue, brown, purple, red). Each voxel of tumor only has one pseudo color value. The tumor pseudo color map data set is completed for display on a display input/output device 3304, 4404. Meanwhile the different threshold values may be used to process in step 115 for calculating different threshold OPP % histogram map for analyzing previous treatment response.

In step 117 the tumor volume change ratio (Vt) may be calculated by the processor 4402 (FIG. 8), 3302 (FIG. 7). The total tumor volume before treatment is defined as original volume V_{O}. The each measurement of tumor volume during treatment can be calculated by accounting tumor region Vt.

$$( {V}_{t} ) \% = \frac{( {V}_{t} - {V}_{o} )}{{V}_{o}} \% \qquad ( 3 )$$

Where, V_{O} is the tumor original volume at pre-treatment; Vt is the volume of tumor response to treatment. When tumor decreases volume, Vt % shows a negative percentage. If tumor volume increases during treatment, Vt % shows a positive percentage. The Vt % parameter directly correlates to cancer response to previous treatment. The step 117 is from common knowledge.

In step 118, special threshold maps may be created by the processor 4402 (FIG. 8), 3302 (FIG. 7) to visualize the data such as using reconstruction OPP % to form pseudo color image of the data in step 116. The three-dimensional pseudo color map data set can be used to visualize tumor different oxygenated perfusion distribution and therapeutic response. 2D pseudo images may displayed as slice by slice on an I/O Interface 4404 (FIG. 8), 3304 (FIG. 7), printer or display screen of a server 3300 and/or an electronic device 4400. The image may be displayed either all pseudo color or only interested pseudo colors image for visualization. For example, by selecting brown, purple, and red color, it may display tumor high oxygenated perfusion area which may be used to evaluate the tumor prognostic information. The dark blue and blue regions correlate to regions of low/non oxygenated perfusion. By selecting dark blue, blue, and light blue colors it may display the tumor low/non oxygenated perfusion image which may be used to monitor the change this part during the course of treatment. As low/non oxygenated perfusion regions of tumor displaying dark blue, blue, and light blue color region of images, they may be fussed to radiation treatment plan for functional image guided irradiation therapy. Next in step 119, the OPP % and Vt % may be drawn on an evaluation diagram 200 (FIGS. 2-6) which may be displayed on an I/O Interface 4404, 3304, printer or display screen of a server 3300 and/or an electronic device 4400. In some embodiments, a reconstruction tumor oxygenated perfusion percentage OPP % pseudo color image may be displayed or during the course of the cancer treatment on a display input/output device 4404, 3304. In further embodiments, the oxygenated perfusion percentage data OPP % and volume change ratio Vt % obtained before a cancer treatment course may be plotted and the oxygenated perfusion percentage data OPP % and volume change ratio Vt % obtained during the cancer treatment course may be plotted on the treatment evaluation diagram 200. In still further embodiments, the oxygenated perfusion percentage data OPP % and volume change ratio Vt % data obtained during a first cancer therapy for a particular patient 501 may be plotted on the first change in tumor volume coordinate graph 212 extending from the poor oxygenated perfusion apex 201 and the first well oxygenated perfusion apex 211 of the cancer treatment evaluation diagram, and wherein the oxygenated perfusion percentage data OPP % and volume change ratio Vt % data obtained during a second cancer therapy for the particular patient 501 may be plotted on the second change in tumor volume coordinate graph 222 extending from the poor oxygenated perfusion apex 201 and the second well oxygenated perfusion apex 221 of the cancer treatment evaluation diagram 200.

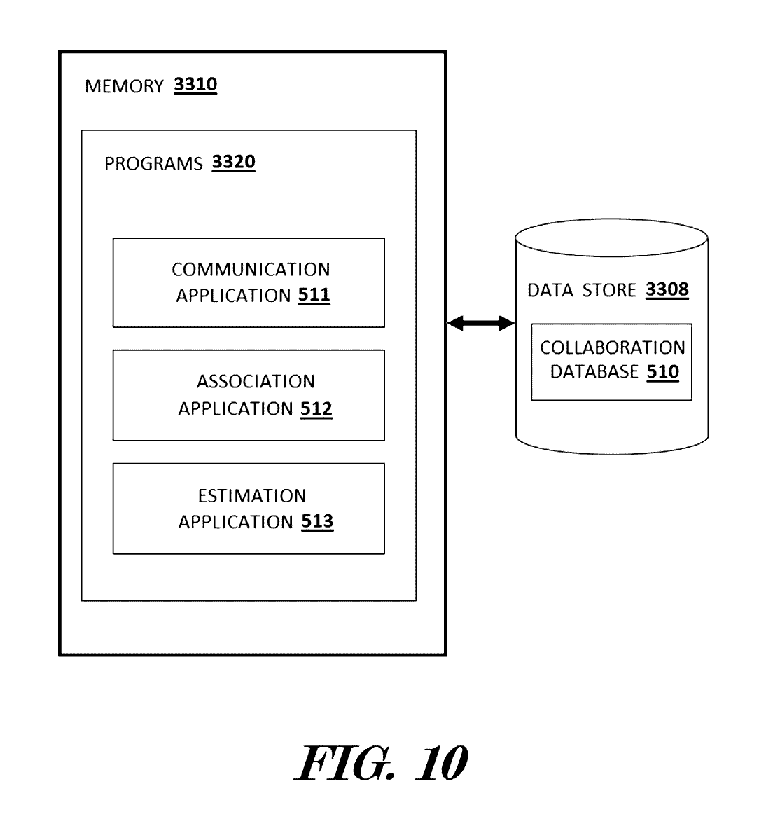

Next in step 120, a risk/benefit analysis for a cancer therapy treatment scheme may be calculated by an estimation application 513 (FIG. 10) based on the pooled cancer therapy data of one or more other patients which may be stored in a collaboration database 510 (FIG. 10). In further embodiments, the oxygenated perfusion percentage data OPP % and volume change ratio Vt % data for a particular patient 501 may be compared to a database, such as a collaboration database 510, containing a pool of cancer therapy data, oxygenated perfusion percentage data OPP %, and volume change ratio Vt % for one or more other patients 501 to provide a risk/benefit analysis for a cancer therapy to the particular patient After step 120, the method 100 may end 121.

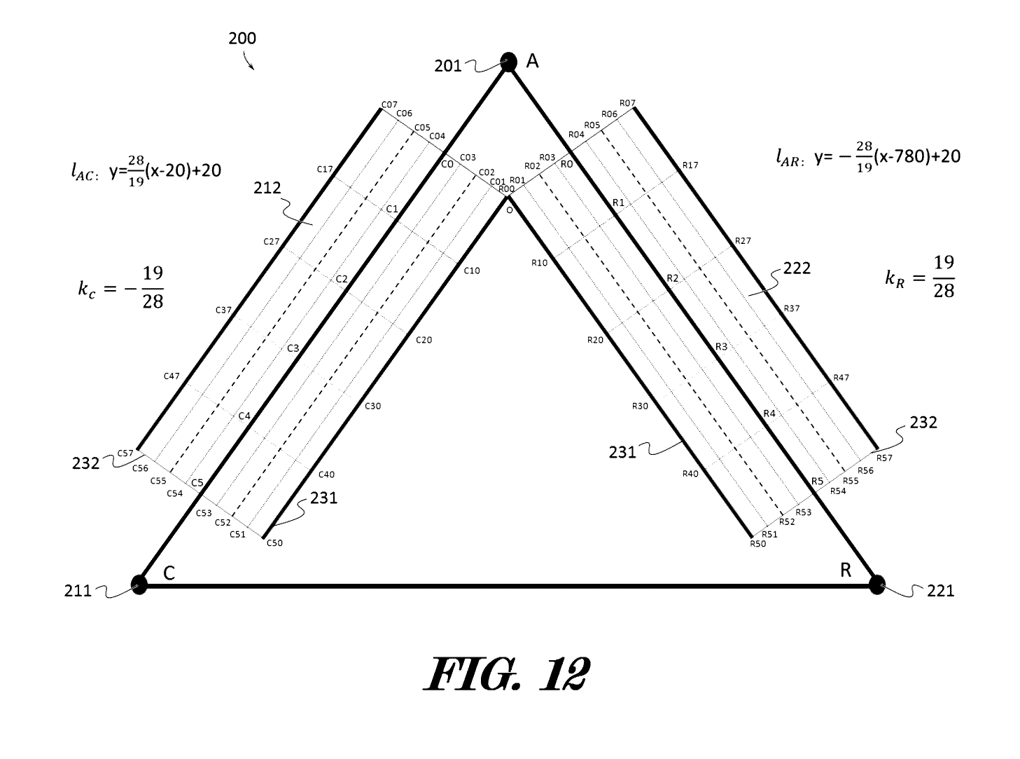

FIG. 12 provides an example of a cancer treatment evaluation diagram 200 according to various embodiments described herein. It should be understood that a cancer treatment evaluation diagram 200 may be drawn or composed in any shape, but to further understanding of the invention, some example equations are provided which may be used to construct all or portions of a cancer treatment evaluation diagram 200. In this example, the diagram 200 may be constructed with an area of 800 by 600 pixels, although other sizes and scales may be used, with the coordinates of A being (400,580), C being (20,20), R being (780,20), R00 being (400,437), C00 being (400,437), O being (400,437).

In some embodiments, the 201 to 211 side (side AC) of the diagram 200 may be drawn according to the following equation:

$${l}_{AC} \text{:} y = \frac{28}{19} ( x - 20 ) + 20$$

In some embodiments, the slope of the 201 to 211 side (side AC) of the diagram 200 may follow the equation:

$${k}_{C} = - \frac{19}{28}$$

In some embodiments, the 201 to 221 side (side AR) of the diagram 200 may be drawn according to the following equation:

$${l}_{AR} \text{:} y = - \frac{28}{19} ( x - 780 ) + 20$$

In some embodiments, the slope of the 201 to 221 side (side AR) of the diagram 200 may follow the equation:

$${k}_{R} = \frac{19}{28}$$

FIG. 2 illustrates an example of a novel cancer treatment evaluation diagram (“the diagram”) 200 according to various embodiments described herein. In some embodiments, the diagram 200 may comprise two independent symmetrical coordination systems as a triangle structure comprising three apexes which may be oriented to different cancer therapy modalities. The poor oxygenated perfusion apex 201, optionally oriented at the top of the triangle, may indicate cancer tumors with poor oxygenated perfusion, a first therapy-well oxygenated perfusion apex 211, and a second therapy-well oxygenated perfusion apex 221, optionally oriented at the bottoms of the triangle, may indicate cancer tumors with well oxygenated perfusion. In this non-limiting example, the first therapy-well oxygenated perfusion apex 211 is used to graph blood-borne therapy data, and the second therapy-well oxygenated perfusion apex 221 is used to graph irradiation therapy data. In other embodiments, data of any therapy may be graphed on any desired apex or side of the diagram 200. Additionally, a change in tumor volume coordinate graph 212, 222, may extend from both of the two sides, such as the 201 to 211 side and the 201 to 221 side of the diagram 200. In this manner the 201 to 211 side and the 201 to 221 side of the diagram 200 may be used as a coordinate graphing system which each side functioning as a coordinate graphing system for a type of cancer therapy or treatment. For example, the first change in tumor volume coordinate graph 212 of the 201 to 211 side may function as a graphing system for a blood-borne drug/agent therapy and the second change in tumor volume coordinate graph 222 of the 201 to 221 side may function as a graphing system for an irradiation therapy. In further embodiments, the diagram 200 may have any number of sides and each side may represent any therapy.

Preferably, each change in tumor volume coordinate graph 212, 222, may comprise an oxygenated perfusion percentage (OPP %) x-axis 231 which may be used to graph oxygenated perfusion percentage (OPP %) data and each change in tumor volume coordinate graph 212, 222, may also comprise a tumor volume change ratio (Vt %) y-axis 232 which may be used to graph tumor volume change ratio (Vt %) data. In this example, negative values on the tumor volume change ratio (Vt %) y-axes 232 may be plotted inside the triangular shaped diagram 200, while positive values on the tumor volume change ratio (Vt %) y-axes 232 may be plotted outside the triangular shaped diagram 200. Also in this example, smaller values on the oxygenated perfusion percentage (OPP %) x-axes 231 may be plotted closer to the poor oxygenated perfusion apex 201 of the triangular shaped diagram 200, while greater values on the oxygenated perfusion percentage (OPP %) x-axes 231 may be plotted closer to the first 211 and second 221 therapy-well oxygenated perfusion apexes of the triangular shaped diagram 200. In alternative embodiments, the orientations and graduations of the oxygenated perfusion percentage (OPP %) x-axes 231 and/or tumor volume change ratio (Vt %) y-axes 232 may be switched, inverted, or otherwise rearranged.

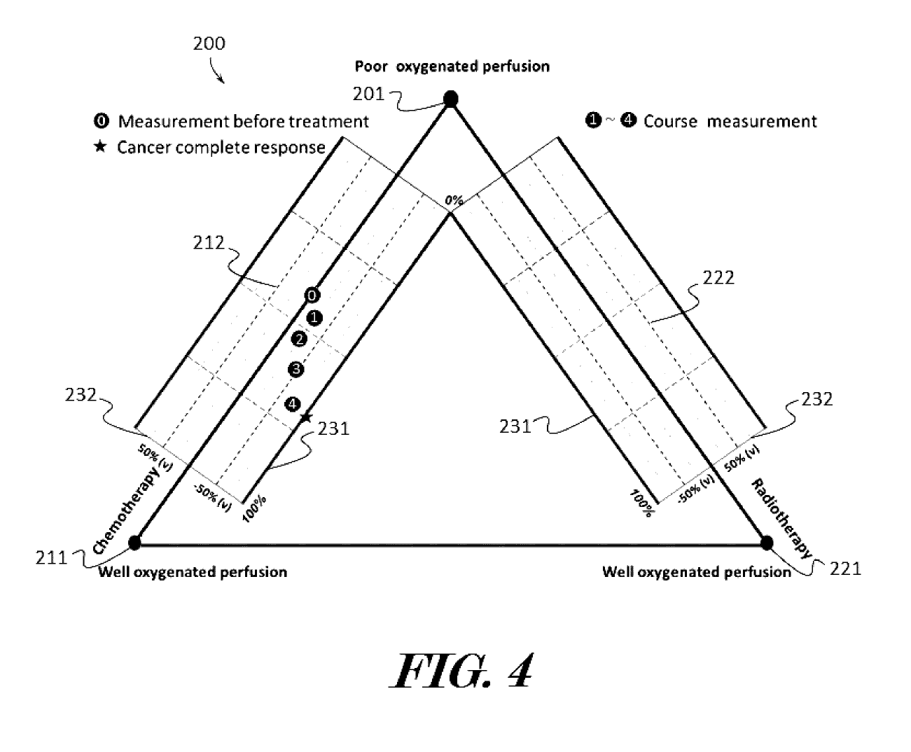

Each measurement, such as those recorded in steps 115 and 117 of the method 100 (FIG. 1) may result with two values (the cancer oxygenated perfusion percentage (OPP %)) and the volume change ratio (Vt %) which may be expressed as one solid point in the coordinate system. A long axis, such as the 201 to 211 side and the 201 to 221 side, of the coordination system between 0%˜100% represents tumor parameter OPP %, whose the higher OPP % value correlates higher oxygenated blood perfusion and better drug/agent/oxygen delivery in tumor region and relative high dose distribution and oxygenation level around vessel. The short axis extending from the two sides of coordination system between −100%˜100% represents the therapeutic response in volume domain, where −100% means a clinical complete response and volume change ratio between −100%˜−30% means tumor shrinkage and shows clinical partial response as shown in FIGS. 4-6, change between −30%˜0% means clinical stable and positive percentage means an increase of tumor volume during treatment. If a cancer has therapeutic complete response, the solid point is marked using previous OPP % value (FIG. 4). The OPP factor on long axis (201 to 211 side and the 201 to 221 side) represents cancer prognostic information correlating to next outcomes; the volume ratio on short axis (extending from both short axes) represents the cancer response to previous treatment.

The two separated coordination systems may be used to evaluate two different treatment modalities. For example, the left side (201 to 211 side) of a triangular diagram 200 may be assigned to evaluate treatment modalities or treatment schemes which are mostly depending on blood-borne therapeutic molecules, particles, and cells therapies (such as chemotherapy, immunotherapy, gene therapy, photodynamic therapy, and developing molecularly targeted therapy, etc.), while the right side (201 to 221 side) of the triangular diagram 200 may be assigned to evaluate irradiation therapy modalities (such as, hyperthermia therapy, radiation therapy, etc.). In some embodiments, the left side (201 to 211 side) of a triangular diagram 200 may be assigned to evaluate a first cancer therapy treatment modality or treatment scheme and the right side (201 to 221 side) of a triangular diagram 200 may be assigned to evaluate a second cancer therapy treatment modality or treatment scheme. A cancer therapy treatment modality or treatment scheme may include, but is not limited to, chemotherapy, molecular targeted therapy, immunotherapy, gene therapy, photodynamic therapy, radiation therapy, hyperthermia therapy, chemotherapy-radiotherapy combinations, molecular targeted therapy-radiotherapy combinations, immunotherapy-radiotherapy combinations, gene therapy-radiotherapy combinations, photodynamic therapy-radiotherapy combination, radiosensitizer-radiotherapy combination, chemotherapy-hyperthermia therapy combination, molecular targeted therapy-hyperthermia therapy combination, immunotherapy-hyperthermia therapy combination, gene therapy-hyperthermia therapy combination, photodynamic therapy-hyperthermia therapy combination, hyperthermia therapy-radiotherapy combination.

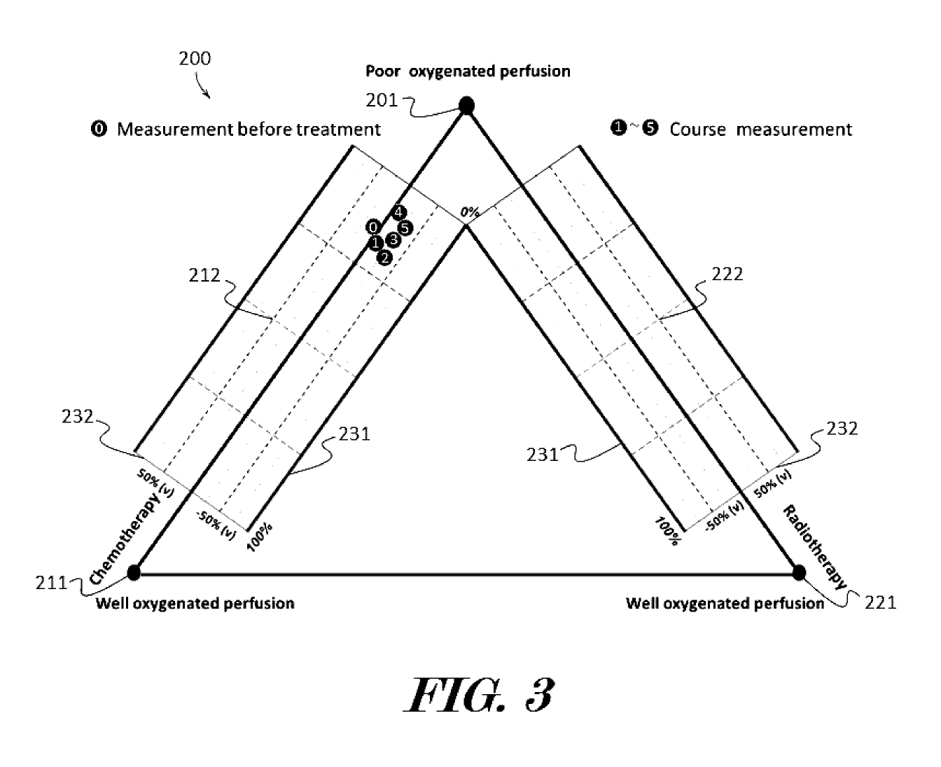

Turning now to FIGS. 3-6, oxygenated perfusion percentage data OPP % and volume change ratio Vt % from one, two, three, four, five, six, seven, eight, or more treatment course time points, such as during a cancer therapy treatment course or treatment scheme may be plotted on a cancer treatment evaluation diagram 200

FIG. 3 shows an example of a cancer treatment evaluation diagram 200 which describes an ineffective chemotherapy cancer treatment, while FIG. 4 depicts an example of a cancer treatment evaluation diagram 200 which describes an effective chemotherapy cancer treatment according to various embodiments described herein. For a chemotherapy to be successful, it must satisfy two requirements: (1) the relevant drug/agent must be effective distribution in the in vivo orthotopic microenvironment of tumors, and (2) this drug/agent must penetrate cancer cells membrane and accumulate enough dose in cells. Generally, patients and clinicians must weigh the risks and benefits of different cancer treatment options (such as, Dose-Dense chemotherapy, Maximum Tolerated Dose (MTD) chemotherapy, and Low Dose Metronomic (LDM) chemotherapy). For poor oxygenated perfusion tumor patient, it may lead to a suboptimal the treatment scheme of Maximum Tolerated Dose (MTD) chemotherapy and patients may suffer side effects, which decrease patient quality of life and increase cost of care. Clinical studies have shown most of human cancers representing poor microcirculatory perfusion and hypoxia, which is one of main reasons causing failure in treatment. Currently, the new approach involves the concept that the higher the dose the greater the therapeutic efficacy and the lower the probability that drug-resistant mechanism will have the opportunity to develop. This concept led to therapeutic regimens of dose intensity and high-dose chemotherapy in the hope of achieving higher cure rates in advanced cancers. The higher Oxygenated Perfusion Percentage (OPP %) represents the relative better dose concentration around tumor cells and may correlate to better response to high-dose chemotherapy. However, if increased therapeutic dose with a better drug/agent distribution cancer doesn't conduct better response, then drug resistance of the cancer cells should be considered in order to apply an early change of the therapies plan for the cancer precision treatment.

The evaluation diagrams 200 of two cases in chemotherapy are shown in FIGS. 3 and 4. The lower oxygenated perfusion percentage (OPP %) demonstrates poor drug/agent delivery, lower dose concentration distribution in tumor region and following ineffective treatments (FIG. 3). The higher oxygenated perfusion percentage case correlates more effective drug/agent delivery and higher dose/agent concentration distribution and better outcomes (FIG. 4).

As shown in FIG. 3, the lower oxygenated perfusion factor of all six measurements correlates to poor drug/agent delivery and following ineffective outcomes for the chemotherapy/blood-borne therapy used to create the data points in FIG. 3. Since the five measurements taken during the course of treatment do not change appreciably from the measurement before treatment, the cancer treatment evaluation diagram 200 produced by the cancer therapeutic window evaluation method of FIG. 1 shows that the chemotherapy treatment is ineffective on the tumor.

As shown in FIG. 4, the increasing oxygenated perfusion factor of the four measurements taken during treatment and the decrease in tumor Vt % correlates to good drug/agent delivery and following effective outcomes for the chemotherapy/blood-borne therapy used to create the data points in FIG. 4. The cancer treatment evaluation diagram 200 produced by the cancer therapeutic window evaluation method of FIG. 1 shows that the chemotherapy treatment is effective on the tumor.

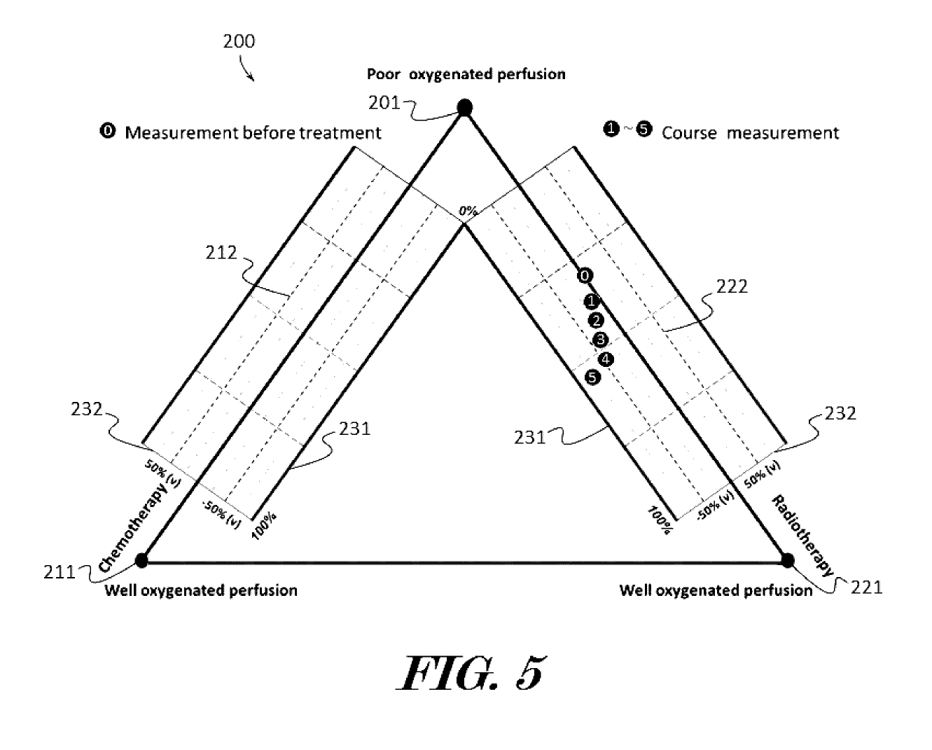

FIG. 5 illustrates an example of a cancer treatment evaluation diagram 200 which describes an effective radiotherapy cancer treatment according to various embodiments described herein. As shown in FIG. 5, the increasing oxygenated perfusion factor of the five measurements taken during radiotherapy treatment and the decrease in tumor Vt % correlates to good oxygen delivery and relative high oxygenation level and following effective outcomes for the radiation therapy used to create the data points in FIG. 5. Since the five measurements taken during the course of treatment do change appreciably from the measurement before treatment, the cancer treatment evaluation diagram 200 produced by the cancer treatment evaluation method of FIG. 1 shows that the radiotherapy treatment is effective for treating the tumor. After a few fractions of a fractional radiotherapy therapy are given to the patient, the reoxygenation of hypoxic tumor cells occurs during fractionated radiotherapy, which may predict a good outcome. The higher oxygenated perfusion percentage factor correlates more effective oxygen distribution, higher oxygenation level of tumor region around vessel, and better outcomes. With fractional radiotherapy, the continuing reoxygenation of hypoxic cancer cells correlates with good therapeutic outcomes. The cancer treatment evaluation diagram 200 can be used to detect tumor reoxygenation phenomenon during a course of radiation therapy for evaluating response in real time. So far there is no other approach to detect tumor reoxygenation phenomenon in clinical routine.

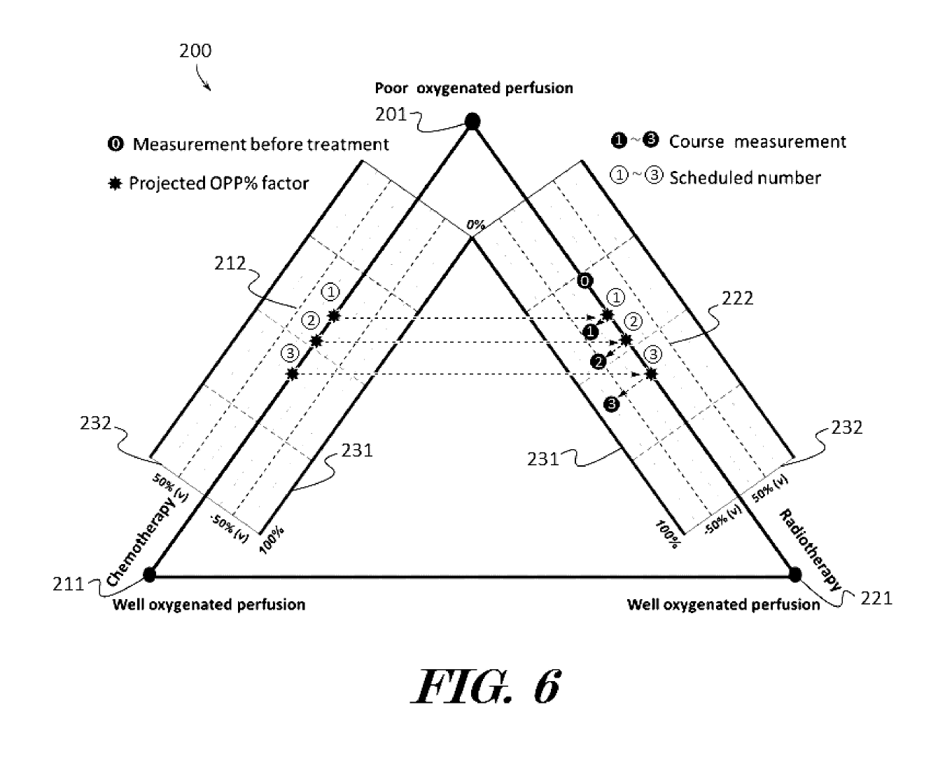

FIG. 6 shows an example of a cancer treatment evaluation diagram 200 which describes an effective chemo-radiotherapy combination cancer treatment according to various embodiments described herein. The OPP % value being projected in both asymmetric both coordination systems represent the ongoing chemotherapy and radiotherapy; the tumor volume parameter is marked at right side for evaluating the combination therapy results.

Combination cancer therapy is an effective treatment modality that has been widely used in clinical routine. This treatment modality (such as, chemotherapy-radiotherapy and immune-radiotherapy etc.) can use both coordination systems on a triangular diagram 200 for tracking and evaluation. For example, the tumor OPP % information can be marked on the long axis of left side (the 201 to 211 side) of the coordination system, which means an ongoing chemotherapy or immunotherapy. The symmetrical position on the long axis of right side (the 201 to 221 side) of the coordination system also is projected the same marker of OPP %. Combining tumor volume information Vt %, one solid point is determined and marked on right coordination system which means an ongoing radiotherapy. The diagram 200 of combination therapy can be used to comprehensively analyze the consequence of each treatment modality. It also can be used to evaluate the special monotherapy of radiotherapy combining radio-sensitizer injection. If patient needs a continuing monotherapy, this diagram can continue to draw results on one of coordination systems as previous description of monotherapy.

As an important parameter, the higher oxygenated perfusion percentage relates to more effective drug/agent/oxygen delivery and oxygenation distribution. Since the result of combination therapy is the comprehensive effect of both treatments, the higher OPP % can be a benefit to both therapy modalities (blood-borne therapies and radiation therapy). FIG. 6 demonstrates an ideal case of chemo-radiotherapy for tracking and evaluating during treatment course with a cancer treatment evaluation diagram 200. It also can be used to evaluate other combination therapies such as immune-radiotherapy, monotherapy such as radiosensitizer-radiotherapy, or any other type of therapy.

Referring to FIG. 7, in an exemplary embodiment, a block diagram illustrates a server 3300 which may be used in the system 500, in other systems, or standalone. The server 3300 may be a digital computer that, in terms of hardware architecture, generally includes a processor 3302, input/output (I/O) interfaces 3304, a network interface 3306, a data store 3308, and memory 3310. It should be appreciated by those of ordinary skill in the art that FIG. 7 depicts the server 3300 in an oversimplified manner, and a practical embodiment may include additional components and suitably configured processing logic to support known or conventional operating features that are not described in detail herein. The components (3302, 3304, 3306, 3308, and 3310) are communicatively coupled via a local interface 3312. The local interface 3312 may be, for example but not limited to, one or more buses or other wired or wireless connections, as is known in the art. The local interface 3312 may have additional elements, which are omitted for simplicity, such as controllers, buffers (caches), drivers, repeaters, and receivers, among many others, to enable communications. Further, the local interface 3312 may include address, control, and/or data connections to enable appropriate communications among the aforementioned components.

The processor 3302 is a hardware device for executing software instructions. The processor 3302 may be any custom made or commercially available processor, a central processing unit (CPU), an auxiliary processor among several processors associated with the server 3300, a semiconductor-based microprocessor (in the form of a microchip or chip set), or generally any device for executing software instructions. When the server 3300 is in operation, the processor 3302 is configured to execute software stored within the memory 3310, to communicate data to and from the memory 3310, and to generally control operations of the server 3300 pursuant to the software instructions. The I/O interfaces 3304 may be used to receive user input from and/or for providing system output to one or more devices or components. User input may be provided via, for example, a keyboard, touch pad, and/or a mouse. System output may be provided via a display device and a printer (not shown). I/O interfaces 3304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 3306 may be used to enable the server 3300 to communicate on a network, such as the Internet, a wide area network (WAN), a local area network (LAN), and the like, etc. The network interface 3306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 3306 may include address, control, and/or data connections to enable appropriate communications on the network. A data store 3308 may be used to store data. The data store 3308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 3308 may incorporate electronic, magnetic, optical, and/or other types of storage media. In one example, the data store 3308 may be located internal to the server 3300 such as, for example, an internal hard drive connected to the local interface 3312 in the server 3300. Additionally in another embodiment, the data store 3308 may be located external to the server 3300 such as, for example, an external hard drive connected to the I/O interfaces 3304 (e.g., SCSI or USB connection). In a further embodiment, the data store 3308 may be connected to the server 3300 through a network, such as, for example, a network attached file server.

The memory 3310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 3310 may incorporate electronic, magnetic, optical, and/or other types of storage media. Note that the memory 3310 may have a distributed architecture, where various components are situated remotely from one another, but can be accessed by the processor 3302. The software in memory 3310 may include one or more software programs, each of which includes an ordered listing of executable instructions for implementing logical functions. The software in the memory 3310 includes a suitable operating system (O/S) 3314 and one or more programs 3316. The operating system 3314 essentially controls the execution of other computer programs, such as the one or more programs 3316, and provides scheduling, input-output control, file and data management, memory management, and communication control and related services. The one or more programs 3316 may be configured to implement the various processes, algorithms, methods, techniques, etc. described herein.

Referring to FIG. 8, in an exemplary embodiment, a block diagram illustrates an electronic device 4400, which may be used in the system 500 or the like. The term “electronic device” as used herein is a type of electronic device comprising circuitry and configured to generally perform functions such as recording audio, photos, and videos; displaying or reproducing audio, photos, and videos; storing, retrieving, or manipulation of electronic data; providing electrical communications and network connectivity; or any other similar function. Non-limiting examples of electronic devices include; personal computers (PCs), workstations, laptops, tablet PCs including the iPad, cell phones including iOS phones made by Apple Inc., Android OS phones, Microsoft OS phones, Blackberry phones, digital music players, or any electronic device capable of running computer software and displaying information to a user, memory cards, other memory storage devices, digital cameras, external battery packs, external charging devices, and the like. Certain types of electronic devices which are portable and easily carried by a person from one location to another may sometimes be referred to as a “portable electronic device” or “portable device”. Some non-limiting examples of portable devices include; cell phones, smart phones, tablet computers, laptop computers, wearable computers such as watches, Google Glasses, etc. and the like.

The electronic device 4400 can be a digital device that, in terms of hardware architecture, generally includes a processor 4402, input/output (I/O) interfaces 4404, a radio 4406, a data store 4408, and memory 4410. It should be appreciated by those of ordinary skill in the art that FIG. 8 depicts the electronic device 4400 in an oversimplified manner, and a practical embodiment may include additional components and suitably configured processing logic to support known or conventional operating features that are not described in detail herein. The components (4402, 4404, 4406, 4408, and 4410) are communicatively coupled via a local interface 4412. The local interface 4412 can be, for example but not limited to, one or more buses or other wired or wireless connections, as is known in the art. The local interface 4412 can have additional elements, which are omitted for simplicity, such as controllers, buffers (caches), drivers, repeaters, and receivers, among many others, to enable communications. Further, the local interface 4412 may include address, control, and/or data connections to enable appropriate communications among the aforementioned components.

The processor 4402 is a hardware device for executing software instructions. The processor 4402 can be any custom made or commercially available processor, a central processing unit (CPU), an auxiliary processor among several processors associated with the electronic device 4400, a semiconductor-based microprocessor (in the form of a microchip or chip set), or generally any device for executing software instructions. When the electronic device 4400 is in operation, the processor 4402 is configured to execute software stored within the memory 4410, to communicate data to and from the memory 4410, and to generally control operations of the electronic device 4400 pursuant to the software instructions. In an exemplary embodiment, the processor 4402 may include a mobile optimized processor such as optimized for power consumption and mobile applications. The I/O interfaces 4404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 4404 can also include, for example, a serial port, a parallel port, a small computer system interface (SCSI), an infrared (IR) interface, a radio frequency (RF) interface, a universal serial bus (USB) interface, and the like. The I/O interfaces 4404 can include a graphical user interface (GUI) that enables a user to interact with the electronic device 4400. Additionally, the I/O interfaces 4404 may further include an imaging device, i.e. camera, video camera, etc.

The radio 4406 enables wireless communication to an external access device or network. Any number of suitable wireless data communication protocols, techniques, or methodologies can be supported by the radio 4406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, or developing 5G etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 4408 may be used to store data. The data store 4408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 4408 may incorporate electronic, magnetic, optical, and/or other types of storage media.

The memory 4410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 4410 may incorporate electronic, magnetic, optical, and/or other types of storage media. Note that the memory 4410 may have a distributed architecture, where various components are situated remotely from one another, but can be accessed by the processor 4402. The software in memory 4410 can include one or more software programs, each of which includes an ordered listing of executable instructions for implementing logical functions. In the example of FIG. 8, the software in the memory 4410 includes a suitable operating system (O/S) 4414 and programs 4416. The operating system 4414 essentially controls the execution of other computer programs, and provides scheduling, input-output control, file and data management, memory management, and communication control and related services. The programs 4416 may include various applications, add-ons, etc. configured to provide end user functionality with the electronic device 4400. For example, exemplary programs 4416 may include, but not limited to, a web browser, social networking applications, streaming media applications, games, mapping and location applications, electronic mail applications, financial applications, and the like. In a typical example, the end user typically uses one or more of the programs 4416 along with a network.

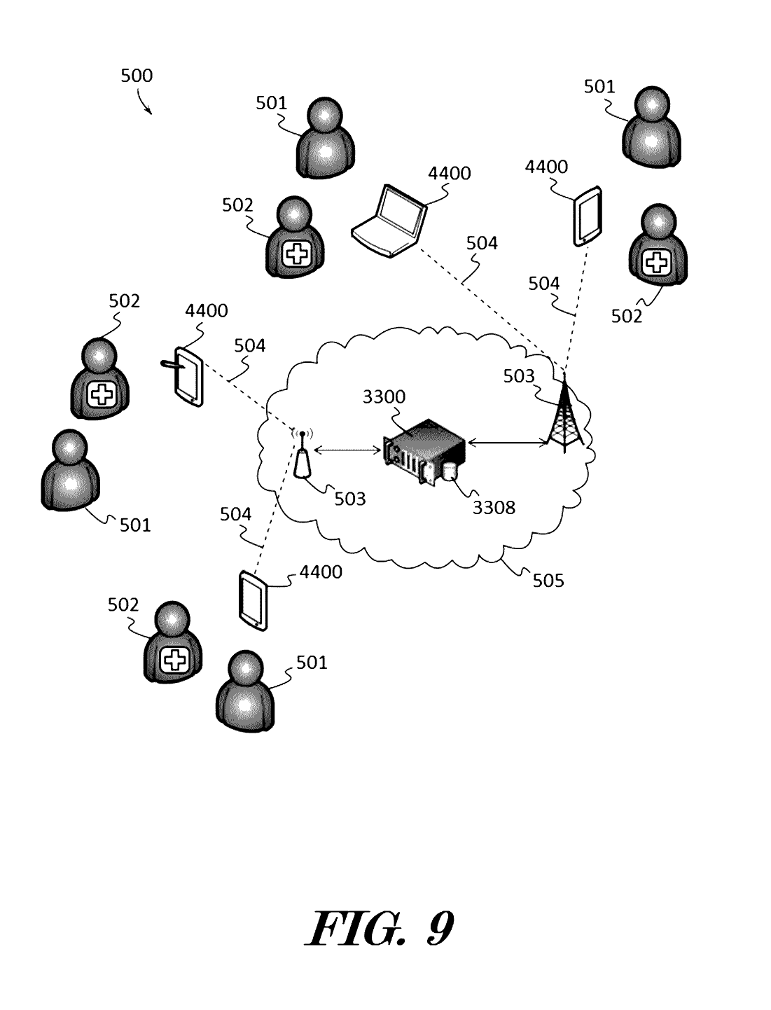

As perhaps best shown by FIG. 9, in some embodiments, as a Therapy-Oriented evaluation tool, a cancer therapeutic window evaluation diagram 200 can be used as a general platform to share tumor prognostic information between clinicians 502 with different treatment modalities backgrounds to allow for clinician 502 collaboration in optimizing a therapeutic strategy before or during a cancer therapy course of treatment for their patients 501. This collaboration may be performed using a cancer treatment evaluation collaboration system (“the system”) 500. The system 500 may receive the health information of a patient 501, such as one or more evaluation diagrams 200, data from one or more diagrams 200, and/or any other data and information related to treatment data, such as sex, age, histopathology, and disease stage, genomic data, treatment plan, which may be stored in a collaboration database 510 and preferably sorted according to treatment site, stage, sex, treatment modality, or any other filtering criteria. Each patient measurement point during a treatment course of a cancer therapy may be collected as therapy response data no matter how effective or ineffective the treatment or therapy is. Based on accumulated and analyzed response data, the system 500 may provide clinicians 502 and patients 501 a quantitative successful probability being calculated by collected similar patient treatment and response data pool and generating a risk/benefit analysis for each treatment modality and scheme in order to optimize the therapeutic strategy and achieve precision cancer treatment. In some embodiments, a risk/benefit analysis may include a comparison between treatment effectiveness and patient's quality of life; the possible outcome and side effects and the dose strength of a cancer therapy. In other embodiments, a risk/benefit analysis may include a comparison between the typical rate of tumor response and one or more selected cancer therapies and/or cancer therapy treatment schemes.

An illustrative example of some of the physical components which may comprise a cancer treatment evaluation collaboration system 500 according to some embodiments is presented in FIG. 9. The system 500 is configured to facilitate the transfer of data and information between one or more access points 503, electronic devices 4400, and servers 3300 over a data network 505. Each electronic device 4400 may send data to and receive data from the data network 505 through a network connection 504 with an access point 503. A data store 3308 accessible by the server 3300 may contain one or more databases. The data may comprise any information pertinent to one or more patients 501, clinicians 502, and/or other users which may be input into the system 500 including information on or describing cancer therapy data of one or more patients 501, information requested by one or more clinicians 502, information supplied by one or more clinicians 502, and any other information which a clinician 502 may use for cancer treatment evaluation and collaboration of one or more patients 501.

In this example, the system 500 comprises at least one electronic device 4400 (but preferably more than two electronic devices 4400) configured to be operated by one or more clinicians 502. In some embodiments, the system 500 may be configured to facilitate the communication of information between one or more clinicians 502, through their respective electronic devices 4400 and/or servers 3300 of the system 500. Electronic devices 4400 can be mobile devices, such as laptops, tablet computers, personal digital assistants, smart phones, and the like, that are equipped with a wired or wireless network interface capable of sending data to one or more servers 3300 with access to one or more data stores 3308 over a network 505 such as a wired local area network or wireless local area network. Additionally, user electronic devices 4400 can be fixed devices, such as desktops, imagining devices, medical workstations, treatment and administration workstations, and the like, that are equipped with a wireless or wired network interface capable of sending data to one or more servers 3300 with access to one or more data stores 3308 over a wireless or wired local area network 505. The present invention may be implemented on at least one electronic device 4400 and/or server 3300 programmed to perform one or more of the steps described herein. In some embodiments, more than one user electronic device 4400 and/or server 3300 may be used, with each being programmed to carry out one or more steps of a method or process described herein.

Referring now to FIG. 10, a block diagram showing some software rules engines which may be found in a system 500 (FIG. 9) which may optionally be configured to run on a server 3300 (FIGS. 7 and 9) and an example of a collaboration database 510 according to various embodiments described herein are illustrated, respectively. In some embodiments, one or more servers 3300 may be configured to run one or more software rules engines or programs such as a communication application 511, association application 512, and/or an estimation application 513. In this embodiment, the applications 511, 512, 513, are configured to run on at least one server 3300. The server 3300 may be in electronic communication with a data store 3308 comprising a database, such as a collaboration database 510. The engines 511, 512, 513, may read, write, or otherwise access data in one or more databases of the data store 308. Additionally, data may be sent and received to and from one or more electronic devices 4400 (FIGS. 8 and 9) which may be in wired and/or wireless electronic communication with the server 3300 through a network 505. In other embodiments, a communication application 511, association application 512, and/or an estimation application 513 may be configured to run on a electronic device 4400 and/or server 3300 with data transferred to and from one or more servers 3300 in communication with a data store 3308 through a network 505. In still further embodiments, a server 3300 or an electronic device 4400 may be configured to run a communication application 511, association application 512, and/or an estimation application 513.

In some embodiments, the system 500 may comprise a database, such as a collaboration database 510, optionally stored on a data store 3308 accessible to a communication application 511, association application 512, and/or an estimation application 513. In further embodiments, a collaboration database 510 may be stored on a data store 4408 of an electronic device 4400. A collaboration database 510 may comprise any data and information pertinent to one or more patients 501 and/or clinicians 502 of the system 500. This data may include information which may describe the cancer therapy, results of cancer therapy, and other health information which may describe a patient 501. For example, this health information may include oxygenated perfusion percentage data OPP %, volume change ratio Vt % data, imaging data, types of cancer therapies received, durations of cancer therapies received, doses of cancer therapies received, or any other health information which may describe one or more patients 501 of a clinician 502. Additionally, the data of two or more patients 501 and/or clinicians 502 may be pooled so that the all the information which may describe the cancer therapy, results of cancer therapy, and other health information of all of the patients 501 in the collaboration database 510 may be searched.

The communication application 511 may comprise a computer program which may be executed by a computing device processor, such as a processor 3302 (FIG. 7) and/or a processor 4402 (FIG. 8), and which may be configured to govern electronic communication between severs 3300 and electronic devices 4400. Data from severs 3300 and electronic devices 4400 may be received by the communication application 511 which may then electronically communicate the data to the association application 512 and estimation application 513. Likewise, data from the association application 512 and estimation application 513 may be received by the communication application 511 which may then electronically communicate the data to servers 3300 and electronic devices 4400. In some embodiments, the communication application 511 may govern the electronic communication by initiating, maintaining, reestablishing, and terminating electronic communication between one or more electronic devices 4400 and servers 3300. In further embodiments, the communication application 511 may control the network interface 3306 (FIG. 7) of the server 3300 to send and receive data to and from one or more electronic devices 4400 and other servers 3300 through a network connection 504 (FIG. 9) over a network 505 (FIG. 9).

The association application 512 may comprise a computer program which may be executed by a computing device processor, such as a processor 3302 (FIG. 7) and/or a processor 4402 (FIG. 8), and which may be configured to store, retrieve, modify, create, and/or delete data and information which may describe the cancer therapy, results of cancer therapy, and other health information of a patient 501, including oxygenated perfusion percentage data OPP %, volume change ratio Vt % data, imaging data, types of cancer therapies received, durations of cancer therapies received, doses of cancer therapies received, or any other health information which may describe one or more patients 501 of a clinician 502 into and from the collaboration database 510. In some embodiments, the association application 512 receive data from the communication application 511 and/or estimation application 513 and associate the data with information which may describe the cancer therapy, results of cancer therapy, and other health information of a patient 501, including oxygenated perfusion percentage data OPP %, volume change ratio Vt % data, imaging data, types of cancer therapies received, durations of cancer therapies received, doses of cancer therapies received, or any other health information which may describe one or more patients 501 of a clinician 502 into the collaboration database 510. In further embodiments, the association application 512 retrieve data from the collaboration database 510, such as information which may describe the cancer therapy, results of cancer therapy, and other health information of a patient 501, including oxygenated perfusion percentage data OPP %, volume change ratio Vt % data, imaging data, types of cancer therapies received, durations of cancer therapies received, doses of cancer therapies received, or any other health information which may describe one or more patients 501 of a clinician 502, and send or communicate the data to the communication application 511 and/or estimation application 513.

The estimation application 513 may comprise a computer program which may be executed by a computing device processor, such as a processor 3302 (FIG. 7) and/or a processor 4402 (FIG. 8), and which may be configured to compare data received from the communication application 511 to data received from the association application 512. In some embodiments, the estimation application 513 may compare the health information of a particular patient 501 received by the communication application 511 through the electronic device 4400 of a clinician 502 to the health information of one or more patients 501, including the pooled health information and data of all the patients 501 in the collaboration database 510, retrieved by the association application 512 from the collaboration database 510. The estimation application 513 may be configured to generate a risk/benefit analysis of how the cancer tumor of the particular patient 501 would respond to a cancer therapy that the particular patient 501 has not yet received based upon the oxygenated perfusion percentage data OPP % and volume change ratio Vt % pooled data of the identified one or patients in the collaboration database 510 that did undergo the cancer therapy that the particular patient has not yet received. Based on the pooled and analyzed response data, the estimation application 513 of the system 500 may provide clinicians 502 and patients 501 a quantitative risk/benefit analysis for each treatment modality and scheme in order to optimize the therapeutic strategy and achieve precision cancer treatment.

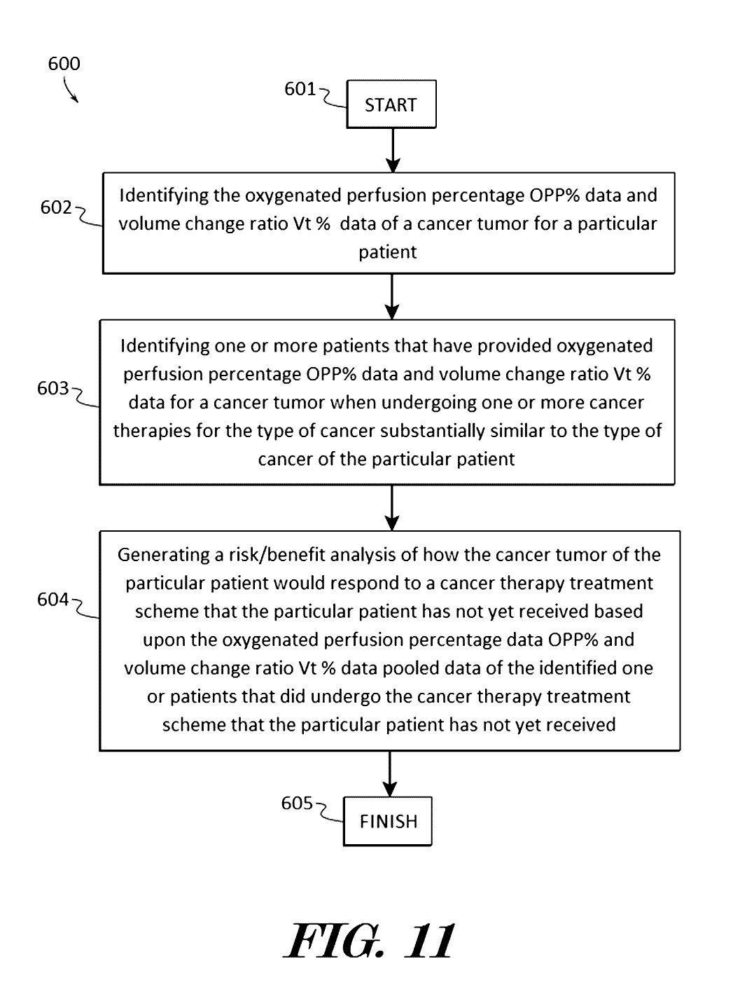

FIG. 11 shows a block diagram of an example of a computer-implemented method for generating an estimation of how the cancer of a particular patient would respond to a cancer therapy (“the method”) 600 which may utilize one or more cancer treatment evaluation diagrams 200 and a cancer treatment evaluation collaboration system 500 according to various embodiments described herein. In some embodiments, the method 600 may be used to provide clinicians 502 and patients 501 a quantitative risk/benefit analysis for each cancer therapy treatment modality or treatment scheme in order to optimize the therapeutic strategy and achieve precision cancer treatment using one or more electronic devices 4400 and/or servers 3300. One or more steps of the method 600 may be performed by a communication application 511, an association application 512, and/or a estimation application 513 which may be executed by the processor of an electronic device, such as a processor 3302 (FIG. 7) and/or a processor 4402 (FIG. 8). In some embodiments, the method 600 may be used for the treatment of human solid tumors, although in further embodiments, the method 600 may be used for the treatment of solid tumors in any mammal or other organism.

In some embodiments, the method 600 may start 601 and the oxygenated perfusion percentage data OPP % and volume change ratio Vt % data of a cancer tumor for a particular patient 501 (FIG. 9) may be identified in step 602. In further embodiments, step 602 may be performed using steps 110-115 of the cancer therapeutic window evaluation method 100 of FIG. 1. In still further embodiments, step 118 and/or 119 of the cancer therapeutic window evaluation method 100 of FIG. 1 may also be performed in step 602. This data may be communicated by a communication application 511 (FIG. 10) and an association application 512 (FIG. 10) to a collaboration database 510 (FIG. 10).

Next, in step 603 one or more patients 501 that have provided oxygenated perfusion percentage data OPP % and volume change ratio Vt % data, such as by one or more steps of the cancer therapeutic window evaluation method 100 of FIG. 1, for a cancer tumor when undergoing one or more cancer therapies for the type of cancer substantially similar to the type of cancer of the particular patient 501 may be identified in the collaboration database 510 by the association application 512. Preferably, the association application 512 may retrieve this data without retrieving any personally identifying information of the one or more patients 501.

In step 604, a risk/benefit analysis of how the cancer tumor of the particular patient 501 would respond to a cancer therapy treatment scheme that the particular patient 501 has not yet received may be generated by the estimation application 513 based upon the oxygenated perfusion percentage data OPP % and volume change ratio Vt % pooled data in the collaboration database 510 of the identified one or patients 501 that did undergo the cancer therapy treatment scheme that the particular patient 501 has not yet received. In some embodiments, the risk/benefit analysis may include how the percentage of tumor complete response and partial response for each particular therapeutic modality. In further embodiments, a risk/benefit analysis may include a comparison between treatment effectiveness and patient's quality of life; the possible outcome and the side effects and the dose strength of a cancer therapy. In other embodiments, a risk/benefit analysis may include a comparison between the typical rate of tumor response and one or more selected cancer therapies and/or cancer therapy treatment schemes. A risk/benefit analysis may be generated for each cancer therapy that has been administered to one or more patients having health information, such as oxygenated perfusion percentage data OPP % and volume change ratio Vt % data, for a substantially similar type of cancer as the particular patient 501. After step 604, the method 600 may finish 605.

It will be appreciated that some exemplary embodiments described herein may include one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ΔSICs), in which each function or some combinations of certain of the functions are implemented as custom logic. Of course, a combination of the two approaches may be used. Moreover, some exemplary embodiments may be implemented as a computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), a Flash memory, and the like.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine generated electrical, optical, or electromagnetic signal that is generated to encode information for transmission to suitable receiver apparatus for execution by a computer. The computer readable medium can be a machine readable storage device, a machine readable storage substrate, a memory device, a composition of matter effecting a machine readable propagated signal, or a combination of one or more of them.

A computer program (also known as a program, software, software application, application, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors (computing device processors) executing one or more computer applications or programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, solid state drives, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network or the cloud. The relationship of client and server arises by virtue of computer programs running on the respective computers and having a client server relationship to each other.

Further, many embodiments are described in terms of sequences of actions to be performed by, for example, elements of a computing device. It will be recognized that various actions described herein can be performed by specific circuits (e.g., application specific integrated circuits (ΔSICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The computer system may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by processor. In addition, the main memory may be used for storing temporary variables or other intermediate information during the execution of instructions by the processor. The computer system may further include a read only memory (ROM) or other static storage device (e.g., programmable ROM (PROM), erasable PROM (EPROM), and electrically erasable PROM (EEPROM)) coupled to the bus for storing static information and instructions for the processor.

The computer system may also include a disk controller coupled to the bus to control one or more storage devices for storing information and instructions, such as a magnetic hard disk, and a removable media drive (e.g., floppy disk drive, read-only compact disc drive, read/write compact disc drive, compact disc jukebox, tape drive, and removable magneto-optical drive). The storage devices may be added to the computer system using an appropriate device interface (e.g., small computer system interface (SCSI), integrated device electronics (IDE), enhanced-IDE (E-IDE), direct memory access (DMA), or ultra-DMA).

The computer system may also include special purpose logic devices (e.g., application specific integrated circuits (ΔSICs)) or configurable logic devices (e.g., simple programmable logic devices (SPLDs), complex programmable logic devices (CPLDs), and field programmable gate arrays (FPGAs)).

The computer system may also include a display controller coupled to the bus to control a display, such as a cathode ray tube (CRT), liquid crystal display (LCD) or any other type of display, for displaying information to a computer user. The computer system may also include input devices, such as a keyboard and a pointing device, for interacting with a computer user and providing information to the processor. Additionally, a touch screen could be employed in conjunction with display. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer system performs a portion or all of the processing steps of the invention in response to the processor executing one or more sequences of one or more instructions contained in a memory, such as the main memory. Such instructions may be read into the main memory from another computer readable medium, such as a hard disk or a removable media drive. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

As stated above, the computer system includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system, for driving a device or devices for implementing the invention, and for enabling the computer system to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code or software code of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

Various forms of computer readable media may be involved in carrying out one or more sequences of one or more instructions to processor for execution. For example, the instructions may initially be carried on a magnetic disk of a remote computer. The remote computer can load the instructions for implementing all or a portion of the present invention remotely into a dynamic memory and send the instructions over the air (e.g. through a wireless cellular network or WiFi network). A modem local to the computer system may receive the data over the air and use an infrared transmitter to convert the data to an infrared signal. An infrared detector coupled to the bus can receive the data carried in the infrared signal and place the data on the bus. The bus carries the data to the main memory, from which the processor retrieves and executes the instructions. The instructions received by the main memory may optionally be stored on storage device either before or after execution by processor.

The computer system also includes a communication interface coupled to the bus. The communication interface provides a two-way data communication coupling to a network link that is connected to, for example, a local area network (LAN), or to another communications network such as the Internet. For example, the communication interface may be a network interface card to attach to any packet switched LAN. As another example, the communication interface may be an asymmetrical digital subscriber line (ADSL) card, an integrated services digital network (ISDN) card or a modem to provide a data communication connection to a corresponding type of communications line. Wireless links may also be implemented. In any such implementation, the communication interface sends and receives electrical, electromagnetic or optical signals that carry digital data streams representing various types of information.

The network link typically provides data communication to the cloud through one or more networks to other data devices. For example, the network link may provide a connection to another computer or remotely located presentation device through a local network (e.g., a LAN) or through equipment operated by a service provider, which provides communication services through a communications network. In preferred embodiments, the local network and the communications network preferably use electrical, electromagnetic, or optical signals that carry digital data streams. The signals through the various networks and the signals on the network link and through the communication interface, which carry the digital data to and from the computer system, are exemplary forms of carrier waves transporting the information. The computer system can transmit and receive data, including program code, through the network(s) and, the network link and the communication interface. Moreover, the network link may provide a connection through a LAN to a user device or client device such as a personal digital assistant (PDA), laptop computer, tablet computer, smartphone, or cellular telephone. The LAN communications network and the other communications networks such as cellular wireless and wifi networks may use electrical, electromagnetic or optical signals that carry digital data streams. The processor system can transmit notifications and receive data, including program code, through the network(s), the network link and the communication interface.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A cancer therapeutic window evaluation method for a particular patient implemented by an electronic device comprising a processor, a data input/output device, and a display input/output device in which data is visualized on a cancer treatment evaluation diagram wherein the diagram comprises two independent symmetrical coordination systems as a triangle structure having a poor oxygenated perfusion apex, a first well oxygenated perfusion apex, a second well oxygenated perfusion apex, a first change in tumor volume coordinate graph extending from the poor oxygenated perfusion apex and the first well oxygenated perfusion apex, and a second change in tumor volume coordinate graph extending from the poor oxygenated perfusion apex and the second well oxygenated perfusion apex, and wherein the method comprises the steps of:
a. acquiring tumor baseline data of the particular patient generated by dynamic contrast enhanced T2-weighted MR imaging technique with a data input/output device;
b. acquiring tumor enhanced data of the particular patient with increasing body blood oxyhemoglobin (HbO₂) concentration, which is generated by same dynamic contrast enhanced T2-weighted MR imaging technique, with a data input/output device;
c. calculating tumor volume based on acquired tumor T2-weighted MR imaging data with the processor;
d. calculating the tumor volume change ratio (Vt %) data with the processor;
e. calculating tumor voxel's enhanced signal intensity (ΔSI) data with the processor;
f. calculating tumor oxygenated perfusion percentage (OPP %) data with the processor;
g. calculating different thresholds of oxygenated perfusion percentage OPP % data and maps with the processor;
h. creating special threshold maps with the processor;
i. plotting OPP % data and Vt % data of the particular patient on the evaluation diagram with the processor on the display input/output device; and
j. calculating a risk/benefit analysis for a cancer therapy treatment scheme based on the pooled cancer therapy data of one or more other patients.

2. The method of claim 1, wherein the method further comprises displaying a reconstruction tumor oxygenated perfusion percentage OPP % pseudo color image during the course of the cancer treatment on the display input/output device.

3. The method of claim 1, wherein the method further comprises plotting the oxygenated perfusion percentage OPP % data and volume change ratio Vt % data obtained before the cancer treatment course and plotting the oxygenated perfusion percentage OPP % data and volume change ratio Vt % data obtained during the cancer treatment course on the treatment evaluation diagram.

4. The method of claim 1, wherein the oxygenated perfusion percentage data OPP % and volume change ratio Vt % data for a particular patient is compared to a database containing a pool of cancer therapy data, oxygenated perfusion percentage OPP % data, and volume change ratio Vt % data for one or more other patients to provide a risk/benefit analysis for a cancer therapy to the particular patient.

5. The method of claim 1, wherein the oxygenated perfusion percentage OPP % data and volume change ratio Vt % data obtained during a first cancer therapy for a particular patient is plotted on the first change in tumor volume coordinate graph extending from the poor oxygenated perfusion apex and the first well oxygenated perfusion apex of the cancer treatment evaluation diagram, and wherein the oxygenated perfusion percentage OPP % data and volume change ratio Vt % data obtained during a second cancer therapy for the particular patient is plotted on the second change in tumor volume coordinate graph extending from the poor oxygenated perfusion apex and the second well oxygenated perfusion apex of the cancer treatment evaluation diagram.

6. The method of claim 5, wherein the first cancer therapy is selected from the group consisting essentially of: chemotherapy, molecular targeted therapy, immunotherapy, gene therapy, photodynamic therapy, chemotherapy-radiotherapy combinations, molecular targeted therapy-radiotherapy combinations, immunotherapy-radiotherapy combinations, gene therapy-radiotherapy combinations, photodynamic therapy-radiotherapy combination, radiosensitizer-radiotherapy combination, chemotherapy-hyperthermia therapy combination, molecular targeted therapy-hyperthermia therapy combination, immunotherapy-hyperthermia therapy combination, gene therapy-hyperthermia therapy combination, photodynamic therapy-hyperthermia therapy combination, hyperthermia therapy-radiotherapy combination.

7. The method of claim 5, wherein the second cancer therapy is selected from the group consisting essentially of: chemotherapy, molecular targeted therapy, immunotherapy, gene therapy, photodynamic therapy, radiation therapy, hyperthermia therapy, chemotherapy-radiotherapy combinations, molecular targeted therapy-radiotherapy combinations, immunotherapy-radiotherapy combinations, gene therapy-radiotherapy combinations, photodynamic therapy-radiotherapy combination, radiosensitizer-radiotherapy combination, chemotherapy-hyperthermia therapy combination, molecular targeted therapy-hyperthermia therapy combination, immunotherapy-hyperthermia therapy combination, gene therapy-hyperthermia therapy combination, photodynamic therapy-hyperthermia therapy combination, hyperthermia therapy-radiotherapy combination.

8. The method of claim 1, wherein oxygenated perfusion percentage OPP % data and volume change ratio Vt % data from two or more treatment course time points are plotted on the cancer treatment evaluation diagram.

9. The method of claim 1, wherein the method is used for the treatment of human solid tumors.

10. The method of claim 1, wherein the method is used for the treatment of mammal solid tumors.

11. A method for generating an estimation of how the cancer of a particular patient would respond to a cancer therapy the particular patient has not yet received for achieving evidence-based precision medicine, the method comprising:
a. identifying the oxygenated perfusion percentage OPP % data and volume change ratio Vt % data of a cancer tumor for a particular patient;
b. identifying one or more patients that have provided oxygenated perfusion percentage OPP % data, volume change ratio Vt % data and treatment schemes for a cancer tumor when undergoing one or more cancer therapies for the type of cancer substantially similar to the type of cancer of the particular patient; and
c. generating a risk/benefit analysis of how the cancer tumor of the particular patient would respond to a cancer therapy treatment scheme that the particular patient has not yet received based upon the oxygenated perfusion percentage data OPP % and volume change ratio Vt % data pooled data of the identified one or patients that did undergo the cancer therapy treatment scheme that the particular patient has not yet received;
d. wherein the method is performed by one or more electronic devices.

12. The method of claim 11, wherein oxygenated perfusion percentage data OPP % and volume change ratio Vt % data is visualized on a cancer treatment evaluation diagram wherein the diagram comprises two independent symmetrical coordination systems as a triangle structure having a poor oxygenated perfusion apex, a first well oxygenated perfusion apex, a second well oxygenated perfusion apex, a first change in tumor volume coordinate graph extending from the poor oxygenated perfusion apex and the first well oxygenated perfusion apex, and a second change in tumor volume coordinate graph extending from the poor oxygenated perfusion apex and the second well oxygenated perfusion apex.

13. The method of claim 11, wherein the method further comprises displaying a reconstruction tumor oxygenated perfusion percentage OPP % pseudo color image during the course of the cancer treatment on a display of an electronic device.

14. The method of claim 11, wherein the method further comprises plotting the oxygenated perfusion percentage data OPP % and volume change ratio Vt % data obtained before the cancer treatment course and plotting the oxygenated perfusion percentage data OPP % and volume change ratio Vt % data obtained during the cancer treatment course on the treatment evaluation diagram.

15. The method of claim 11, wherein the method further comprises plotting the oxygenated perfusion percentage data OPP % and volume change ratio Vt % data obtained before and during the cancer treatment course on the treatment evaluation diagram to determine if the patient has Multiple Drug Resistance for chemotherapy agents and Drug Resistance for new targeted therapy drugs in cancer treatment.

16. The method of claim 11, wherein the method further comprises plotting the oxygenated perfusion percentage data OPP % and Reconstruction OPP % map obtained during the cancer radiation treatment course to determine where tumor low oxygenation regions are accurately located for the purposes of radiotherapy.

17. The method of claim 11, wherein the oxygenated perfusion percentage OPP % data and volume change ratio Vt % data for a particular patient is compared to a database containing pooled cancer therapy data, oxygenated perfusion percentage OPP % data, and volume change ratio Vt % data for one or more other patients to provide a risk/benefit analysis for a cancer therapy to the particular patient.

18. The method of claim 11, wherein the oxygenated perfusion percentage OPP % data and volume change ratio Vt % data obtained during a first cancer therapy for a particular patient is plotted on the first change in tumor volume coordinate graph extending from the poor oxygenated perfusion apex and the first well oxygenated perfusion apex of the cancer treatment evaluation diagram, and wherein the oxygenated perfusion percentage OPP % data and volume change ratio Vt % data obtained during a second cancer therapy for the particular patient is plotted on the second change in tumor volume coordinate graph extending from the poor oxygenated perfusion apex and the second well oxygenated perfusion apex of the cancer treatment evaluation diagram.

19. The method of claim 18, wherein the first cancer therapy is selected from the group consisting essentially of: chemotherapy, molecular targeted therapy, immunotherapy, gene therapy, photodynamic therapy, radiation therapy, hyperthermia therapy, chemotherapy-radiotherapy combinations, molecular targeted therapy-radiotherapy combinations, immunotherapy-radiotherapy combinations, gene therapy-radiotherapy combinations, photodynamic therapy-radiotherapy combination, radiosensitizer-radiotherapy combination, chemotherapy-hyperthermia therapy combination, molecular targeted therapy-hyperthermia therapy combination, immunotherapy-hyperthermia therapy combination, gene therapy-hyperthermia therapy combination, photodynamic therapy-hyperthermia therapy combination, hyperthermia therapy-radiotherapy combination, and wherein the second cancer therapy is selected from the group consisting essentially of: chemotherapy, molecular targeted therapy, immunotherapy, gene therapy, photodynamic therapy, radiation therapy, hyperthermia therapy, chemotherapy-radiotherapy combinations, molecular targeted therapy-radiotherapy combinations, immunotherapy-radiotherapy combinations, gene therapy-radiotherapy combinations, photodynamic therapy-radiotherapy combination, radiosensitizer-radiotherapy combination, chemotherapy-hyperthermia therapy combination, molecular targeted therapy-hyperthermia therapy combination, immunotherapy-hyperthermia therapy combination, gene therapy-hyperthermia therapy combination, photodynamic therapy-hyperthermia therapy combination, hyperthermia therapy-radiotherapy combination.

20. The method of claim 11, wherein oxygenated perfusion percentage OPP % data and volume change ratio Vt % data from two or more treatment course time points are plotted on the cancer treatment evaluation diagram.
